(19) United States
(12) Patent Application Publication
(10) Pub. No.: US 2020/0062266 A1
(43) Pub. Date: Feb. 27, 2020

(54) OPERATION SUPPORT SYSTEM FOR WORKING MACHINE AND AGRICULTURE SUPPORT SYSTEM

(71) Applicant: KUBOTA CORPORATION, Osaka (JP)

(72) Inventors: Kazuo SAKAGUCHI, Osaka (JP); Naohiro SAIJO, Osaka (JP); Yasuhiro NISHIDA, Osaka (JP)

(73) Assignee: KUBOTA CORPORATION, Osaka (JP)

(21) Appl. No.: 16/667,240

(22) Filed: Oct. 29, 2019

Related U.S. Application Data
(63) Continuation of application No. PCT/JP2018/015720, filed on Apr. 16, 2018.

(30) Foreign Application Priority Data
May 10, 2017 (JP) 2017-94141
May 10, 2017 (JP) 2017-94142
May 10, 2017 (JP) 2017-94143

(51) Int. Cl. B60W 40/08; G05D 1/00; G05D 1/02

(52) U.S. Cl. CPC B60W 40/08; G05D 1/0055; B60W 2040/0863; B60W 2040/0872; G05D 2201/0201; G05D 1/0212

(57) ABSTRACT

An operation support system for a working machine includes a biological condition detector device to detect vital data of an operator, the biological condition detector device being attached to the operator, a relating portion to relate the biological condition detector device to the working machine configured to travel, an abnormality detector to detect, from the vital data, abnormality of the operator to which the biological condition detector device related to the working machine is attached, and a stopping controller to stop the working machine related to the biological condition detector device when the abnormality detector detects the abnormality of the operator, the biological condition detector device being attached to the operator.

### CROSS-REFERENCE TO RELATED APPLICATIONS

The present application is a continuation application of International Application No. PCT/JP 2018/015720, filed Apr. 16, 2018, which claims priority to Japanese Patent Application No. 2017/094141, filed May 10, 2017, to Japanese Patent Application No. 2017/094142, filed May 10, 2017, and to Japanese Patent Application No. 2017/094143, filed May 10, 2017. The contents of these applications are incorporated herein by reference in their entirety.

### BACKGROUND OF THE INVENTION

### Field of the Invention

The present invention relates to an operation support system for a working machine and to an agriculture support system.

### Description of Related Art

Japanese Unexamined Patent Application Publication No. 2015-049872 discloses a system for managing the agricultural working. The system disclosed in Japanese Unexamined Patent Application Publication No. 2015-049872 includes a working content storage means for storing work contents to be performed on an agricultural field, a working plan storage means for storing a working plan in which an agricultural working and an agricultural working period are related to each other, and a mobile terminal assigned to an agricultural operator. The mobile terminal requests the working content storage means for the working contents directed to the agricultural operator assigned to the mobile terminal, and has an obtaining means for requesting the working plan storage means for the working plan, and a display means for displaying the working plan and/or the working plan obtained by the obtaining means.

### SUMMARY OF THE INVENTION

An operation support system for a working machine includes: a biological condition detector device to detect vital data of an operator, the biological condition detector device being attached to the operator; a relating portion to relate the biological condition detector device to the working machine configured to travel; an abnormality detector to detect, from the vital data, abnormality of the operator to which the biological condition detector device related to the working machine is attached; and a stopping controller to stop the working machine related to the biological condition detector device when the abnormality detector detects the abnormality of the operator, the biological condition detector device being attached to the operator.

A working machine includes: a working device to perform working; a traveling device to perform traveling; a first obtaining portion to obtain vital data of the operator from a biological condition detector device configured to detect the vital data of the operator, the biological condition detector device being attached to the operator; an abnormality detector to detect, based on the vital data obtained by the first obtaining portion, abnormality of the operator; and a stopping controller to stop the working device or the traveling device when the abnormality detector detects the abnormality of the operator.

An operation support system for an agricultural machine, includes: a biological condition detector device to detect vital data of an operator who operates the agricultural machine; a position detector device to detect a machine position of the agricultural machine; an agricultural field information obtaining portion to obtain agricultural field information that is information on an agricultural field; and a control device to control the agricultural machine based on the vital data detected by the biological condition detector device, the machine position detected by the position detector device, and the agricultural field information.

An operation support system for an agricultural machine, includes: a biological condition detector device to detect vital data of an operator who operates the agricultural machine; a position detector device to detect a machine position of the agricultural machine; a route obtaining portion to obtain a scheduled traveling route of the agricultural machine; and a control device to control the agricultural machine based on the vital data detected by the biological condition detector device, the machine position detected by the position detector device, and the scheduled traveling route.

An operation support method for an agricultural machine, includes steps of: detecting vital data of an operator who operates the agricultural machine; detecting a machine position of the agricultural machine; obtaining agricultural field information that is information on an agricultural field; and controlling the agricultural machine based on the vital data, the machine position, and the agricultural field information.

An agriculture support system, includes: a biological condition detector device to detect vital data of an operator; a data collecting device to collect operating information of an agricultural machine; and a display device to display information on the vital data detected by the biological condition detector device and display information on the operating information collected by the data collecting device.

### DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a view illustrating an operation support system for a working machine according to a first embodiment of the present invention;

FIG. 2 is a view illustrating a flowchart to relate the working machine to a biological condition detector device according to the first embodiment;

FIG. 3 is a view illustrating a relation between an operator A, an operator B, an operator C, and the working machine according to the first embodiment;

FIG. 4 is a. view illustrating a flowchart from detection of abnormality of the operator to stopping of the working machine by a stopping controller according to the first embodiment;

FIG. 5 is a view illustrating an operation support system for an agricultural machine according to a second embodiment of the present invention;

FIG. 6 is a view illustrating a relation between a machine position and vital data according to the second embodiment;

FIG. 7 is a view illustrating a relation between a boundary of an agricultural field, the machine position, and a distance difference according to the second embodiment;

FIG. 8A is a view illustrating a flowchart showing an operation support for a tractor according to the second embodiment;

FIG. 8B is a view illustrating a modified example of the flowchart showing the operation support for the tractor according to the second embodiment;

FIG. 9 is a. view illustrating an operation support system for an agricultural machine according to a third embodiment of the present invention;

FIG. 10 is a view illustrating an example of a scheduled traveling route of a tractor according to the third embodiment;

FIG. 11A is a view illustrating a flowchart showing an operation support for a tractor according to the third embodiment;

FIG. 11B is a view illustrating a modified example of the flowchart showing the operation support for the tractor according to the third embodiment;

FIG. 12 is a view illustrating an operation support system for an agricultural machine according to a fourth embodiment of the present invention;

FIG. 13 is a view illustrating a flowchart showing an operation support for a tractor according to the fourth embodiment;

FIG. 14 is a view illustrating an agriculture support system according to a fifth embodiment of the present invention;

FIG. 15 is a view illustrating a relation between a machine position and vital data according to the fifth embodiment;

FIG. 16 is a view illustrating a relation between operating information, the machine position, and the vital data according to the fifth embodiment;

FIG. 17 is a view illustrating an operation display screen according to the fifth embodiment;

FIG. 18 is a view illustrating an agriculture support system according to a sixth embodiment of the present invention;

FIG. 19 is a view illustrating an operation display screen according to the sixth embodiment;

FIG. 20 is a view illustrating an operation display screen according to a seventh embodiment of the present invention;

FIG. 21 is a view illustrating a machine position, vital data, operating information in an agricultural field according to the seventh embodiment; and

FIG. 22 is a whole view illustrating a working machine that is a tractor coupled to a cultivating device according to the embodiments.

### DESCRIPTION OF THE EMBODIMENTS

The embodiments will now be described with reference to the accompanying drawings, wherein like reference numerals designate corresponding or identical elements throughout the various drawings. The drawings are to be viewed in an orientation in which the reference numerals are viewed correctly.

Hereinafter, an embodiment of the present invention will be described with reference to the drawings as appropriate.

### First Embodiment

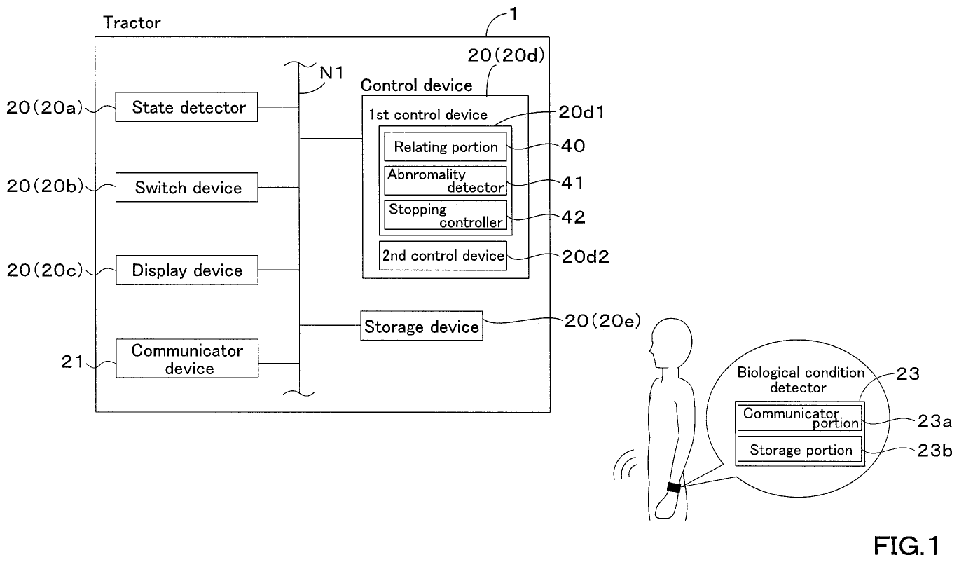

FIG. 1 shows an operation support system for a working machine. The operation support system for the working machine is a system that is configured to support the operation (steering) of the working machine 1. The working machine 1 is a tractor, a combine, a rice transplanter, a snowplow, or the like.

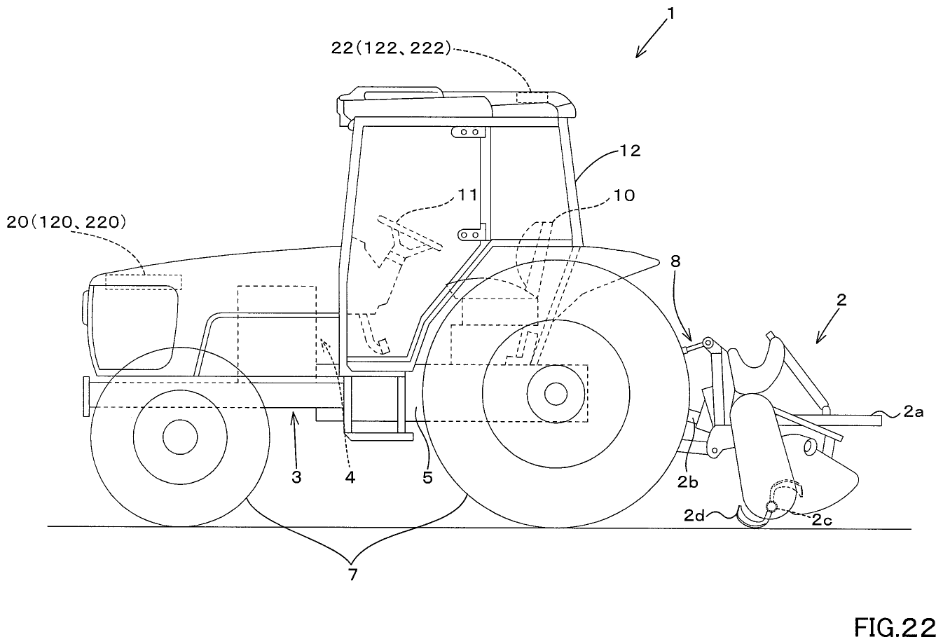

First, the working machine will be described. As shown in FIG. 22, the working machine 1 includes a work device 2, a vehicle (vehicle body) 3 having a traveling device 7, a prime mover 4, and a transmission device 5. The traveling device 7 is a device having a front wheel and a rear wheel. The traveling device 7 may be a crawler type device. The prime mover 4 is a diesel engine, an electric motor, or the like, and is constituted of the diesel engine in this embodiment. The transmission device 5 can switch the propulsive force of the traveling device 7 and can switch the traveling of the traveling device 7 between the forward traveling and the backward traveling. The transmission device 5 includes a traveling clutch that is capable of transmitting power from the prime mover 4, and includes a travel drive shaft that is capable of transmitting the power from the traveling clutch. The traveling clutch can be switched between a connected state in which the power from the prime mover 4 is transmitted to the traveling drive shaft and a disconnected state in which the power from the prime mover 4 is not transmitted to the traveling drive shaft. The traveling clutch is a hydraulic clutch that is switched between the connected state and the disconnected state by pressured fluid or the like from a solenoid valve. That is, when the traveling clutch is constituted of a hydraulic clutch, an electric signal (a control signal) such as an electric current is outputted from the control device 20d described later to the electromagnetic valve, and thereby switching the electromagnetic valve to at least two positions. In this manner, the traveling clutch switches between the connected state and the disconnected state. The traveling clutch may be an electromagnetic clutch that is switched between the connected state and the disconnected state by the electrical signal.

In addition, the transmission device 5 has a PTO clutch capable of transmitting the power from the prime mover 4, and has a PTO shaft capable of transmitting the power from the PTO clutch. The PTO clutch can be switched between a connected state in which the power from the prime mover 4 is transmitted to the PTO shaft and a disconnected state in which the power from the prime mover 4 is not transmitted to the PTO shaft. The traveling clutch is a hydraulic clutch that is switched between the connected state and the disconnected state by the pressured fluid or the like from a solenoid valve. That is, when the PTO clutch is constituted of a hydraulic clutch, an electric signal (a control signal) such as a current is outputted from the control device 20d described later to the electromagnetic valve, and the electromagnetic valve is switched to at least two positions. In this manner, the PTO clutch switches between the connected state and the disconnected state. The PTO clutch may be an electromagnetic clutch that is switched between the connected state and the disconnected state by an electrical signal.

In addition, a coupling portion 8 constituted of a three-point link mechanism or the like is provided at the rear portion of the vehicle body 3. The working device 2 can be attached to and detached from the coupling portion 8. By coupling the working device 2 to the coupling portion 8, the working device 2 can be pulled by the vehicle body 3. The working device 2 includes a tilling device for the plowing, a fertilizer spraying device for spraying fertilizer, an agrochemical spraying device for spraying agricultural chemicals, and a harvesting device for the harvesting. In addition, FIG. 22 shows an example in which the tilling device is attached as the working device 2.

The tillage device 2 has a machine body 2a connected to the coupling portion 8, a drive shaft 2b provided at the front portion of the machine body 2a, a rotary shaft 2c rotatably supported by the machine body 2a, and a working tool 2d attached to the rotary shaft 2c. The drive shaft 2b is connected to a PTO shaft that is driven by the power of the prime mover 4 and the like, and transmits the power of the PTO shaft. The rotary shaft 2c is rotated by the power transmitted to the driving shaft 2b from the PTO shaft. The working tool 2d is, for example, a tilling tine for plowing an agricultural field. That is, the tillage device 2 cultivates the agricultural field while being pulled by the vehicle body 3.

In addition, the working machine 1 includes an operator seat 10 provided on the vehicle body 3, and an operation device 11. The operator seat 10 and the operation device 11 are arranged in a cabin 12 provided in the vehicle body 3. The operation device 11 is a portion installed around the operator seat 10, and includes a portion on which a device, a member, and the like are installed, which operate a machine, a device, an instrument, a member, and the like equipped with the working machine 1 (for example, the working device 2, the vehicle body 3, the prime mover 4, the traveling device 7, the working device, and the like). The operation device 11 includes a operation device including at least a steering.

As shown in FIG. 1, the working machine 1 is equipped with a plurality of devices 20. The plurality of devices 20 are connected by an in-vehicle network N1 such as the CAN, the LIN, or the FlexRay. The device 20 is a device that constitutes the working machine 1, and includes, for example, a state detector device 20a, a switch device 20b, a display device 20c, a control device 20d, and a storage device 20e.

The state detector device 20a is a detector device that detects the state (a machine state) of the working machine 1. The state detector device 20a includes an accelerator pedal sensor, a shift lever detector sensor, a crank position sensor, a fuel sensor, a water temperature sensor, an engine revolving sensor, a steering angle sensor, an fluid temperature sensor, an axle rotation sensor, and the like. The switch device 20b is a device that performs the switching, and is an ignition switch, a parking brake switch, a PTO switch, or the like. The display device 20c is a device that displays various items related to the working machine 1, and is a liquid crystal display device configured with liquid crystal or the like.

The control device 20d includes a first control device 20d1 and a second control device 20d2. The first control device 20d1 is a device that controls a whole of the working machine 1. A detection value detected by the state detector device 20a [for example, an operation amount of the accelerator pedal detected by the accelerator pedal sensor, a shift lever position (speed) detected by the shift lever detector sensor in operating the shift lever, an engine revolving speed detected by the engine revolving speed sensor, a fluid temperature detected by the fluid temperature sensor, a crank position detected by the crank position sensor, and the like] is inputted to the first control device 20d1. The first control device 20d1 outputs a control command to the second control device 20d2 and controls the transmission device 5 based on the shift lever position (controls the speed) so that the engine revolves at a predetermined revolving speed based on the operation amount of the accelerator pedal. In addition, the first control device 20d1 controls the raising/lowering of the coupling portion 8 in accordance with an input from the operation member (the elevation control).

The second control device 20d2 is a device that mainly controls the engine 4. The second control device 20d2 controls an injector, a common rail, a supply pump, and the like based on the inputs such as the operation amount of the accelerator pedal, the crank position, the cam position, and the like. In the engine control in the second control device 20d2, for example, the fuel injection amount, the injection timing, and the fuel injection rate are set in the control of the injector, and the fuel injection pressure is set in the control of the supply pump and the common rail.

The storage device 20e stores various information related to the working machine 1. For example, the storage device 20e stores identification information (second identification information) for identifying the working machine 1. The second identification information is information assigned to each working machine 1, and the working machine 1 can be identified (specified) by the second identification information.

The working machine 1 includes a communication device 21. The communication device 21 is connected to the in-vehicle network N1.

The communication device 21 is a device that outputs data (information) of the working machine 1 to the outside of the working machine 1 and takes external data into the working machine 1. The communication device 21 performs wireless communication using, for example, IEEE 802.11 series of communication standards such as Wi-Fi (Wireless Fidelity, a registered trademark), or performs wireless communication using a mobile phone communication network, a data communication network, a mobile phone communication network, or the like. As will be described later, the communication device (first obtaining portion) 21 obtains the biological condition of the operator from the biological condition detector device 23.

The biological condition detector device 23 is a device that detects the biological condition of the operator. The biological condition detector device 23 is, for example, a sensor or an electrode that measures a biological condition such as an operator's heartbeat, a respiratory rate (breathing), sleeping, a body temperature, sweating, a body posture (body movement), electromyogram (muscle movement), and the like. In addition, the biological condition detector device 23 is a wearable device attached to an operator.

The biological condition detector device 23 includes a communicator portion 23a. The communicator portion 23a is a device that performs a short-range communication. For example, the communicator portion 23a performs wireless communication with the working machine 1 (the communication device 21) by Bluetooth (a registered trademark) Low Energy or the like in the specification of the Bluetooth (a registered trademark) in the communication standard IEEE 802.15.1 series. The biological condition detector device 23 includes a storage portion 23b. The storage portion 23b is a non-volatile memory, for example, stores the identification information (first identification information) for identifying the biological condition detector device 23 or stores vital data detected by the biological condition detector device 2. The first identification information is information assigned to each biological condition detector device 23, and the biological condition detector device 23 can be identified (specified) based on the first identification information.

As described above, the working machine 1 includes the communication device 21, while the biological condition detector device 23 that detects the vital data of an operator is attached to the operator. Thus, the vital data detected by the biological condition detector device 23, that is, the operator's vital data can be transmitted to the working machine 1.

Now, the first control device 20d1 controls the working machine 1 based on the vital data of the operator detected by the biological condition detector device 23. The first control device 20d1 includes a relating portion 40. The relating portion 40 includes an electric/electronic component provided in the first control device 20d1, a computer program incorporated in the first control device 20d1, and the like.

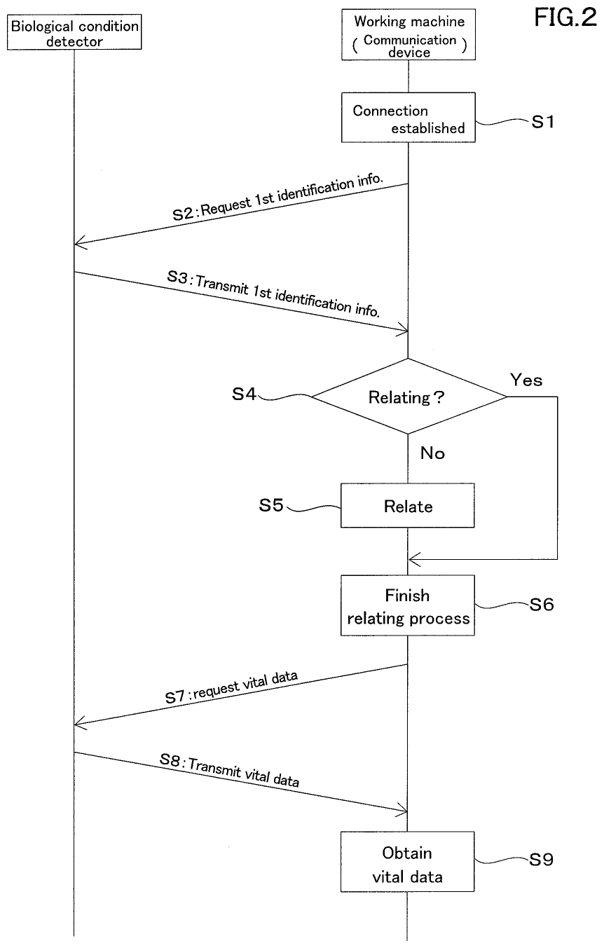

The relating portion 40 associates the biological condition detector device 23 with the working machine 1. As shown in FIG. 2, after the connection between the communicator portion 23a of the biological condition detector device 23 and the communication device 21 of the working machine 1 is established (step S1), the relating portion 40 requests the first identification information to the biological condition detector device 23 (step S2). That is, the relating portion 40 transmits a signal indicating the request for the first identification information to the biological condition detector device 23 through the communication device 21. The biological condition detector device 23 transmits the first identification information to the communication device 21 in response to the request from the relating portion 40 (step S3). The relating portion (a judging portion) 40 judges whether or not the received first identification information and second identification information are associated with each other after the communication device 21 receives the first identification information (step S4). For example, the relating portion (the judging portion) 40 refers to the storage device 20e, and determines that the association is established when the first identification information received by the communication device 21 is stored (step S4, Yes). When the first identification information is not stored, it is determined that the association is not established(step S4, No).

When the first identification information and the second identification information are not associated (step S4, No), the relating portion 40 associates the first identification information with the second identification information (step S5), and stores the associated information (the information associating the first identification information and the second identification information) in the storage device 20e. On the other hand, when first identification information and second identification information are associated (step S4, Yes), the associating process by the relating portion 40 is finished (step S6), and the first control device 20d1 requests the biological condition detector device 23 for the vital data (step S7). That is, the first control device 20d1 transmits a signal requesting the biological condition detector device 23 for the vital data through the communication device 21.

The biological condition detector device 23 sequentially transmits the detected vital data in response to the request from the first control device 20d1 (step S8). The communication device (the first obtaining portion) 21 obtains the operator's vital data transmitted from the biological condition detector device 23 (step S9).

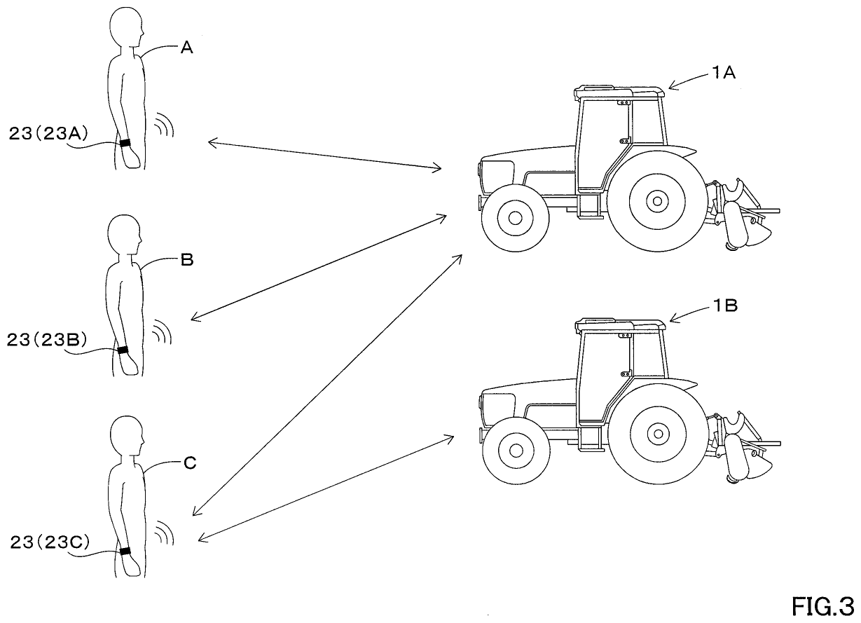

As described above, the working machine 1 and the biological condition detector device 23 can be related (associated) by the relating portion 40. For example, as shown in FIG. 3, it is assumed that the biological condition detector devices 23 are attached to three operators A, B, and C individually. The biological condition detector device 23A attached to the operator A, the biological condition detector device 23B attached to the operator B, and the biological condition detector device 23C attached to the operator C can be associated with the working machine 1A. Only the biological condition detector device 23C attached to the operator C can be associated with the working machine 1B. In this manner, the working machine 1A can obtain the vital data of the operator A, the operator B, and the operator C, and the working machine 1B can obtain the vital data of the operator C.

The first control device 20d1 includes an abnormality detector portion 41. The abnormality detector portion 41 is constituted of an electric/electronic component provided in the first control device 20d1, a computer program incorporated in the first control device 20d1, and the like.

The abnormality detector portion 41 detects, from the vital data, an abnormality of the operator who has the biological condition detector device 23 associated with the working machine 1. For example, in the example of FIG. 3, the abnormality detector portion 41 provided in the working machine 1A can detect each abnormality of the operator A, the operator B, and the operator C. Moreover, the abnormality detection portion 41 provided in the working machine 1B can detect the abnormality of the operator C.

Next, detection of the operator's abnormality by the abnormality detector portion 41 will be described.

When the communication device 21 receives the vital data transmitted from the biological condition detector device 23, the abnormality detector portion 41 judges whether or not the operator is in an abnormal state (an abnormal condition) from the received vital data. For example, the abnormality detector portion 41 judges, based on the body posture (the body movement) included in the vital data, whether or not the operator has leaned. And, when it is determined that the operator has leaned, a signal (a leaning signal) indicating that the operator is in a leaning state is outputted. Alternatively, the abnormality detector portion 41 judges, based on the heartbeat, the breathing (the respiratory rate), the body temperature, the sweating, and the like, whether or not the operator is in a bad physical condition. And, when the operator is in the bad physical condition, the abnormality detector portion 41 outputs a signal (a bad signal) indicating that the operator is in the bad physical condition, that is, the operator is in an abnormal state.

As described above, according to the abnormality detector portion 41, the abnormality detector portion 41 can detect that a predetermined operator is in the abnormal state (the leaning of operator, the bad physical condition).

The first control device 20d1 includes a stopping controller portion 42. The stopping controller portion 42 is constituted of an electric/electronic component provided in the first control device 20d1, a computer program incorporated in the first control device 20d1, or the like.

When the abnormality detector portion 41 detects an abnormality of the operator, the stopping controller portion 42 stops the working machine 1 associated with the biological condition detector device 23 attached to the operator. For example, the stopping controller portion 41 provided in the working machine 1A stops the working machine 1A when any abnormality of the operator A, the operator B, or the operator C is detected. In addition, for example, the stopping controller portion 41 provided in the working machine 1B stops the working machine 1B when an abnormality of the operator C is detected.

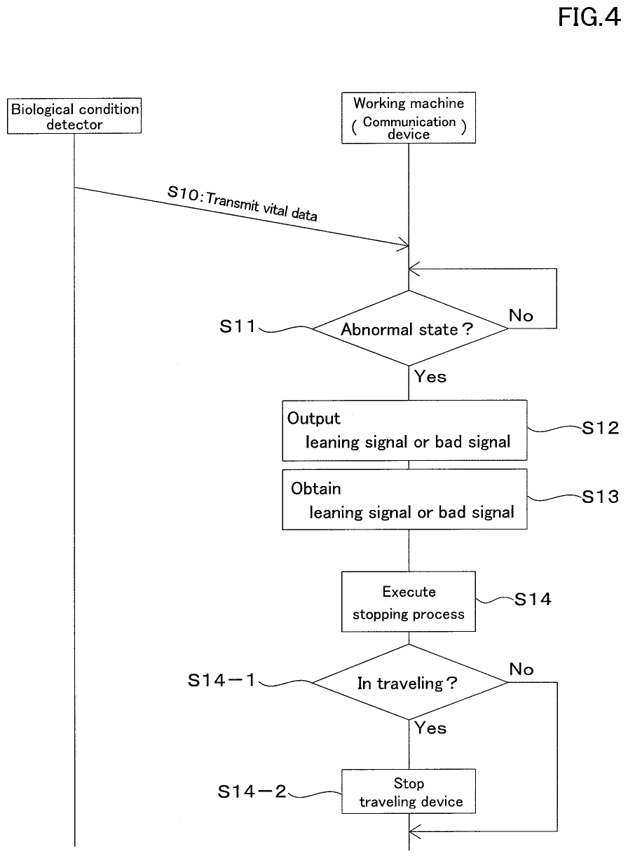

Next, detection of the operator's abnormality by the stopping controller portion 42 will be described. FIG. 4 is a flowchart showing a flow from the detection of abnormal state of the operator to the stopping of the working machine 1 by the stopping controller portion 42. The description will be made on the assumption that the working machine 1 and the biological condition detector device 23 are already associated with each other.

The biological condition detector device 23 sequentially transmits the vital data to the associated working machine 1 (step S10).

When the communication device 21 receives the vital data, the abnormality detector portion 41 judges, based on the vital data, whether the operator is in the abnormal state (step S11). When the abnormality detector portion 41 detects the leaning state of the operator, or when the abnormality detector portion 41 detects the bad physical condition of the operator (step S11, Yes), the abnormality detector portion 41 outputs a leaning signal or a stopping signal to the stopping controller portion 42 (step S12). The stopping controller portion 42 will perform the stopping process of the working machine 1 (step S14) when the leaning signal or the bad signal is obtained (step S13). In the stopping process, the stopping controller portion 42 judges, based on the output of the axle rotation sensor, whether or not the working machine 1 is traveling (step S14-1). For example, when the output of the axle rotation sensor is not zero and the working machine 1 is traveling (step S14-1, Yes), the stopping controller portion 42 outputs an electric signal (a control signal) to the traveling clutch regardless of the operation amount of the accelerator pedal and the shift lever position (a shift position) even when the traveling is ordered by the operation amount of the accelerator pedal and the shift lever position (a shift position), and then the stopping controller portion 42 switches the traveling clutch from the connected state to the disconnected state, thereby stopping the traveling device 7 (step S14-2). Alternatively, in the stopping process, when the working machine 1 is traveling, the stopping controller portion 42 automatically activates the braking device and stops the traveling device 7 even when the brake pedal is not operated. Alternatively, in the stopping process, the stopping controller portion 42 automatically stops the driving of the prime mover 4 when the working machine 1 is traveling.

In the above-described embodiment, the stopping controller portion 42 stops the traveling of the working machine 1 in traveling when the abnormality detector portion 41 detects the abnormality of the operator and the working machine 1 is traveling. However, the working (also referred to as an operation) by the working machine 1 in working may be stopped.

In the stopping process, the stopping controller portion 42 judges, based on the rotation of the PTO shaft or the like, whether or not the working machine 1 is working. For example, when the PTO switch is ON (when the PTO clutch is in the connected state), the stopping controller portion 42 outputs an electric signal (a control signal) to the PTO clutch and switches the PTO clutch from the connected state to the disconnected state. In this manner, the tilling device (the working device) 2 is automatically stopped.

The operation support system for the working machine includes the biological condition detector device 23, the relating portion 40, the abnormality detector portion 41, and the stopping controller portion 42. Thus, in a situation where the operator is working by moving the working machine 1, the working machine 1 associated with the operator can be appropriately stopped when the abnormality of the operator is detected. For example, under a state where there are three operators, the operator A, the operator B, and the operator C, when all the operators (the operator A, the operator B, and the operator C) are associated with the working machine A before the working machine A and the working machine B are activated, the working machine A can be stopped when the abnormality of any one of the operators is detected. In addition, when only the operator C is associated with the working machine B, the working machine B can be stopped when the abnormality of the operator C is detected.

The stopping controller portion 42 stops the traveling of the working machine in traveling when the abnormality detector portion 41 detects the operator's leaning as the abnormality of the operator and the working machine is in traveling. Thus, the traveling of the working machine can be appropriately stopped when the operator leans while the working machine is traveling.

The stopping controller portion 42 stops the working (the operation) of the working machine in working when the abnormality detector portion 41 detects the operator's leaning as the abnormality of the operator and the working machine is in working. Thus, the working of the working machine can be appropriately stopped when the operator leans while the working machine is in working.

When the abnormality detector portion 41 detects a bad physical condition of the operator as the abnormality of the operator and the working machine is in traveling, the stopping controller portion 42 stops the traveling of the working machine in traveling. While the working machine is in traveling, the working machine can be properly stopped when the operator has the bad physical condition in the middle of traveling.

The stopping controller portion 42 stops the working of the working machine in working when the abnormality detector portion 41 detects the bad physical condition of the operator as the abnormality of the operator and the working machine is in working. Thus, while the working machine is in working, the working machine can be properly stopped when the operator has the bad physical condition in the middle of working.

The working machine 1 includes a rotating shaft 2c and a working tool 2d, and the stopping controller portion 42 stops the rotation of the rotating shaft 2c. According to that configuration, when the working machine 1 is, for example, a tilling machine that plows an agricultural field or a snowplow that removes the snow, the tilling machine and the snowplow can be stopped appropriately.

The relating portion 40, the abnormality detector portion 41, and the stopping controller portion 42 are provided in the working machine 1. According to that configuration, the working machine 1 side is capable of being related to the operator (the biological condition detector device 23), and capable of knowing the operator on the working machine 1 side. In addition, when the working machine 1 is provided with the abnormality detector portion 41 and the stopping controller portion 42, the operator can quickly grasp the abnormality on the working machine 1 side, and can quickly stop the working machine 1.

The working machine 1 also includes a judging portion 40 that judges whether or not the biological condition detector device 23 is associated with. The working device 2 or the traveling device 7 is stopped when the judging portion 40 determines that the biological condition detector device 23 is associated with and the abnormality detector portion 41 detects an abnormality of the operator. The judging portion 40 allows the working machine 1 side to quickly know the operator (the biological condition detector device 23) related to the working machine 1. When the abnormality of the operator is detected, the working device 2 or the traveling device 7 can be quickly stopped.

The biological condition detector device 23 is a portable type including the relating portion 40 and the abnormality detector portion 41. Thus, the operator's vital data can be detected without hindering the operator's working and without being restricted from moving within a predetermined range. Thereby, the vital data of the operator can be easily detected.

In the above-described embodiment, the working machine 1 includes the relating portion 40 and the abnormality detector portion 41. Instead of the configuration, the biological condition detector device 23 may include the abnormality detector portion 41, or the biological condition detector device 23 may include the relating portion 40 and the abnormality detector portion 41. In this case, the abnormality detector portion 41 of the biological condition detector device 23 judges, based on the vital data, whether or not the operator is in an abnormal state, and the abnormality detector portion 41 outputs a leaning signal or a bad signal to the working machine 1 (the communication device 21). The stopping controller portion 42 executes the stopping process when the communication device 21 receives the leaning signal or the bad signal.

### Second Embodiment

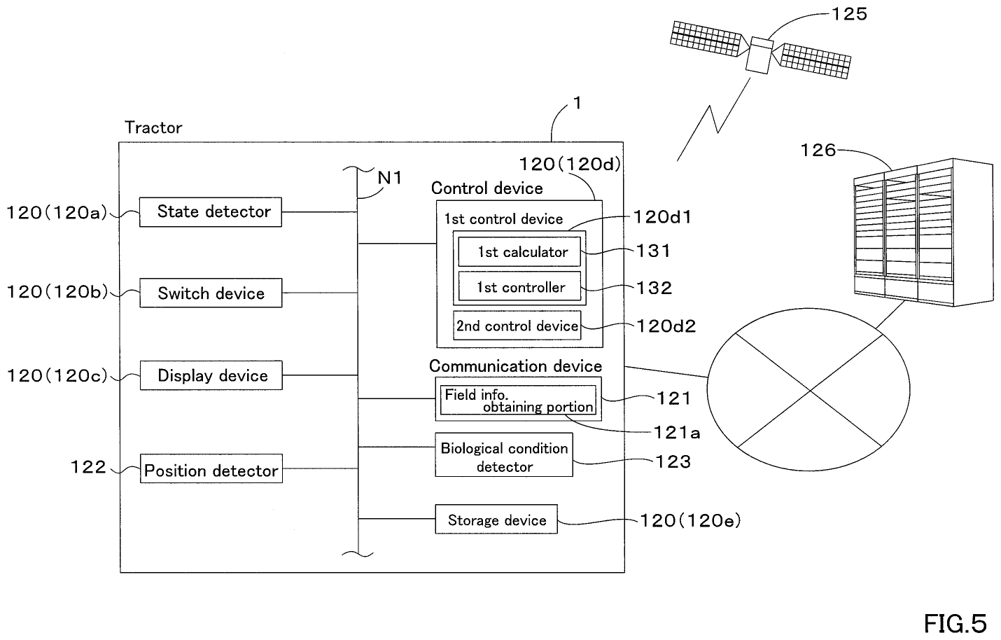

FIG. 5 shows an operation support system for an agricultural machine according to a second embodiment of the present invention. The operation support system for the agricultural machine is a system that is capable of supporting the operation (control) of the agricultural machine 1. In the second embodiment, a configuration different from the first embodiment will be described.

As shown in FIG. 5, the tractor 1 is provided with a plurality of devices 120. The plurality of devices 120 are connected by an in-vehicle network N1 such as the CAN, the LIN, or the FlexRay. The devices 120 are devices constituting the tractor 1 and includes, for example, a state detector device 120a, a switch device 120b, a display device 120c, and a control device 120d.

The state detector device 120a is a detecting device that detects the state (the machine state) of the tractor 1. The state detector device 120a is an accelerator pedal sensor, a shift lever detector sensor, a crank position sensor, a fuel sensor, a water temperature sensor, an engine revolving sensor, a steering angle sensor, an fluid temperature sensor, an axle rotation sensor, and the like. The switch device 120b is a device that performs the switching, and is an ignition switch, a parking brake switch, a PTO switch, or the like. The display device 120c is a device that displays various items related to the tractor 1, and is a liquid crystal display device constituted of liquid crystal or the like.

The control device 120d includes a first control device 120d1 and a second control device 120d2. The first control device 120d1 is a device that controls a whole of the tractor 1. The first control device 120d1 receives a detection value detected by the state detector device 120a [for example, an operation amount of the accelerator pedal detected by the accelerator pedal sensor, a shift lever position(a shift position) detected by the shift lever in operating the shift lever, an engine revolving speed detected by the engine revolving sensor, a fluid temperature detected by the fluid temperature sensor, a crank position detected by the crank position sensor, and the like]. The first control device 120d1 outputs a control command to the second control device 120d2 based on the operation amount of the accelerator pedal such that the engine is driven at a predetermined revolving speed, and controls the transmission device 5 (the shift control) based on the shift lever position. In addition, the first control device 120d1 controls the raising/lowering of the coupling portion 8 based on an input from the operation member (an elevation control). 100431 The second control device 120d2 is a device that mainly controls the engine 4. The second controller 120d2 controls an injector, a common rail, a supply pump, and the like based on the inputs such as the operation amount of the accelerator pedal, the crank position, the cam position, and the like. In the engine control of the second control device 120d2, for example, the fuel injection amount, the injection timing, and the fuel injection rate are set in the control of the injector, and the fuel injection pressure is set in the control of the supply pump and the control of the common rail.

The tractor 1 includes a communication device 121, a position detector device 122, and a biological condition detector device 123. The communication device 121, the position detector device 122, and the biological condition detector device 123 are connected to the in-vehicle network N1.

The communication device 121 has an agricultural field information obtaining portion 121a. The agricultural field information obtaining portion 121a is constituted of an electrical/electronic component provided in the communication device 121, a computer program incorporated in the communication device 121, and the like. The agricultural field information obtaining portion 121a obtains agricultural field information related to the agricultural field. In obtaining the agricultural field information, for example, the agricultural field information obtaining portion 121a requests the communication device 121 to connect to a support device 126 such as a server, and the communication device 121 obtains the agricultural field information stored in the support device 126 from the device 126 in wireless or the like. In this embodiment, the communication device 121 is provided with the agricultural field information obtaining portion 121a, and the agricultural field information stored in the support device 126 is obtained by the agricultural field information obtaining portion 121a. However, the device 120 such as the control device 120d1 may be provided with the agricultural field information obtaining portion 121a. For example, an input interface configured to be connected to the first control device 120d1 may be provided, and when the storage medium is connected to the input interface, the agricultural field information obtaining portion 121a may fetch the agricultural field information stored in the storage medium into the first control device 120d1 through the input interface. The agricultural field information obtained by the agricultural field obtaining portion 121a is stored in the storage device 120e provided in the tractor 1.

The agricultural field information is data (electronic data) indicating the agricultural field, that is, a representative position (latitude and longitude) indicating the agricultural field, a position (latitude and longitude) indicating the boundary of the agricultural field, and the like. In addition, the agricultural field information may be image data of the agricultural field or other data indicating the agricultural field.

The position detector device 122 is a detecting device that is capable of detecting the position of the tractor 1, and is a device that detects the position (latitude, longitude) based on the satellite signal (a radio wave) of the positioning satellite 25, for example. That is, the position detector device 122 detects the position of the vehicle body 3 with used of a satellite positioning system (the Global Positioning System, the Galileo, the GLONASS, etc.). The position detector device 122 is attached to the top plate of the cabin 12, for example. The position detector device 122 may be attached to a portion other than the cabin 12, and may be provided in the working device 2, for example. Hereinafter, for convenience of the explanation, the position (latitude, longitude) detected by the position detector device 122 is referred to as a “machine position”. The machine position detected by the position detector device 122 is stored in the storage device 120e.

The biological condition detector device 123 is a wearable device attached to an operator or is a non-wearable device provided around the operator seat 10. When the biological condition detector device 123 is a wearable device, the vital data detected by the biological condition detector device 123 is transmitted to the communication device 121 through the wireless device housed in the biological condition detector device 123. In addition, when the biological condition detector device 123 is a non-wearing device, the biological condition detector device 123 is connected to the in-vehicle network N1, and the vital data detected by the biological condition detector device 123 is transmitted to the in-vehicle network N1. The biological condition detector device 123 may be an imaging device such as a camera that captures an image of the operator seated on the operator seat 10. The vital data detected by the biological condition detector device 123 is stored in the storage device 120e.

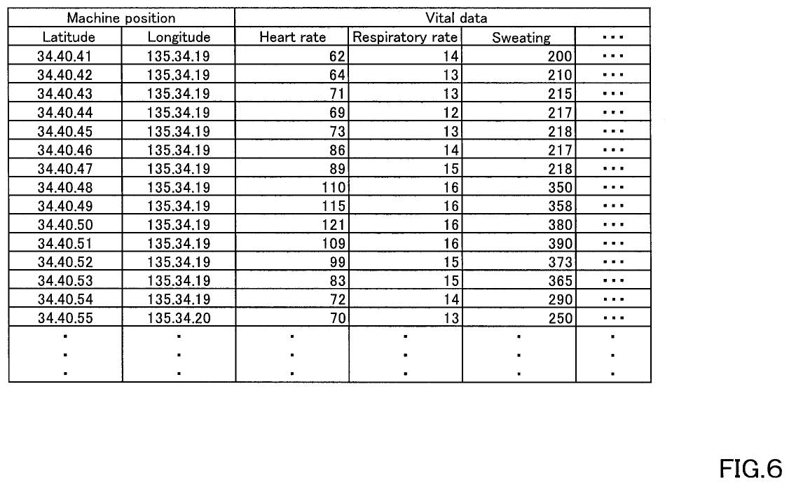

As described above, since the tractor 1 is provided with the position detector device 122 and the biological condition detector device 123, the mechanical position detected by the position detector device 122 and the vital data detected by the biological condition detector device 123 are obtained in association with each other as shown in FIG. 6. In this manner, it is possible to know the vital data of the operator during the tractor 1 is traveling.

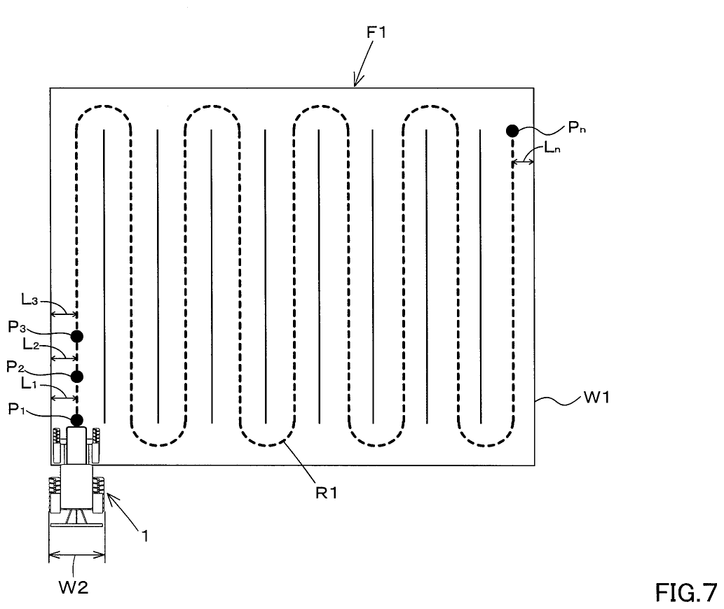

Now, the first control device 120d1 controls the tractor 1 based on the agricultural field information, the machine position detected by the position detector device 122, and the vital data detected by the biological condition detector device 123. In particular, as shown in FIG. 7, when the boundary of the agricultural field F1 indicated by the agricultural field information is represented by a reference numeral “W11” and the machine position detected by the position detector device 122 is represented by a reference numeral “Pn (n=1, 2, 3)”, the first control device 120d1 controls the tractor 1 based on the distance difference Ln between the boundary W1 and the machine position Pn and based on the vital data detected by the biological condition detector device 123. For convenience of the explanation, in FIG. 7, a scheduled traveling route R1 on which an operator plans to travel by operating the tractor 1 is indicated by a broken line.

Next, the first control device 120d1 will be described in detail.

The first control device 120d1 includes a first calculator portion 131 and a first controller portion 132. The first calculator portion 131 and the first controller portion 132 are constituted of an electric/electronic component provided in the first control device 120d1, a computer program incorporated in the first control device 120d1, or the like. The first calculator portion 131 calculates a distance difference Ln between the boundary W1 of the agricultural field F1 and the machine position Pn based on the machine position Pn and the agricultural field information. The first controller portion 132 controls the agricultural machine based on the vital data and the distance difference Ln.

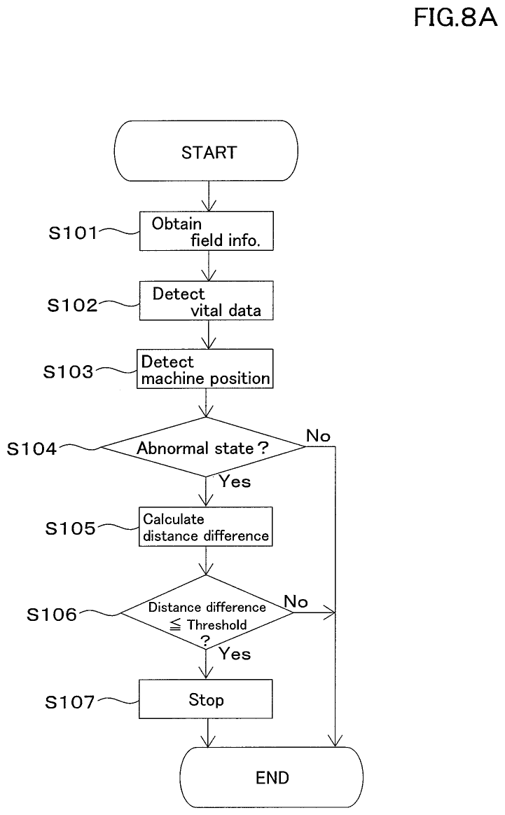

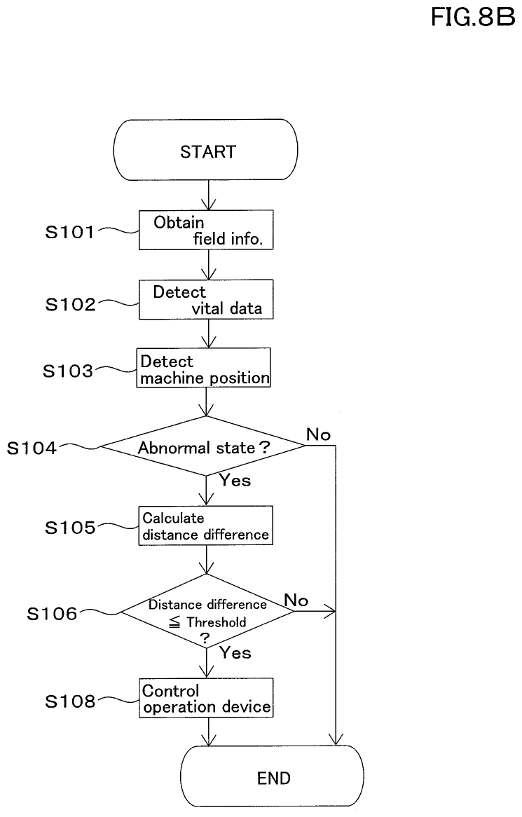

FIG. 8A is a flowchart illustrating the operation support of the tractor 1.

As shown in FIG. 8A, before starting the tractor 1 (before the traveling), the agricultural field information is obtained by the agricultural field information obtaining portion 121a (step S101). After starting the prime mover 4 of the tractor 1, the vital data is detected by the biological condition detector device 123 (step S102), and the mechanical position Pn is detected by the position detector device 122 (step S103).

In addition, after starting the prime mover 4 of the tractor 1, the first controller portion 132 judges whether or not the operator is in an abnormal state (an abnormal condition) based on the detected vital data (step S104). For example, the first controller portion 132 judges whether the operator is awake based on the body movement (the body posture), the electromyogram (muscle movement), and the like included in the vital data, and when the operator is awake, the first controller portion 132 determines that the operator is not in the abnormal state (step S104, No). In addition, the first controller portion 132 judges whether the operator is in the bad physical condition based on the heart rate, the breathing, the body temperature, the sweating, and the like, and when the operator is not in the bad physical condition, the first controller portion 132 determines that the operator is not in the abnormal state (step S104, No). The first controller portion 132 determines that the operator is in the abnormal state when the vital data indicates that the operator is not awake or indicates that the operator is in the bad physical condition (step S104, Yes). Note that the determination of the operator's awakening and the operator's bad physical condition based on the vital data is not limited to the above-described example.

When the operator is in the abnormal state (step S104, Yes), the first calculator portion 131, based on the machine position Pn detected by the position detector device 122, calculates the distance difference Ln between the machine position Pn and the boundary W1 of the agricultural field F1 included in the agricultural field information (step S105). In particular, the first calculator portion 131 calculates the distance difference Ln, which is the shortest linear distance between the machine position Pn and the boundary W1, based on the latitude and longitude indicating the machine position Pn and the latitude and longitude indicating the boundary W1 of the agricultural field F1.

After calculating the distance difference Ln (after step S105), the first controller portion 132 of the first control device 120d1 judges whether or not the distance difference Ln is equal to or less than the threshold value M1 (step S106). The threshold value M1 is a value used for judging whether or not the tractor 1 is located near the boundary W1 of the agricultural field F1, that is, whether or not the tractor 1 is located near the bank of the agricultural field F1. For example, the threshold value M1 is set to be equal to or less than the maximum width W2 of the tractor 1. In other words, the threshold value M1 judges whether or not the tractor 1 is traveling in a position closest to the bank of the agricultural field F1 in the agricultural field F1. For example, as shown in FIG. 7, when the tractor 1 is at the machine position P3, the tractor 1 is near the boundary W1 of the agricultural field F1, and the distance difference L3 is equal to or less than the threshold value M1.

The first controller portion 132 stops the traveling of the tractor 1 (step S107) when the distance difference Ln is equal to or less than the threshold value M1 (step S106, Yes), that is, when the distance difference Ln is equal to or less than the threshold value M1 and the vital data indicates that the operator is not awake or is in the bad physical condition. The first controller portion 132 ignores the operation amount of the accelerator pedal and the shift lever position (the shift position) even when traveling is ordered based on the operation amount of the accelerator pedal and based on the shift lever position (the shift position). For example, the first controller portion 132 stops the traveling device 7 by outputting an electric signal (a control signal) to the traveling clutch to switch the traveling clutch from the connected state to the disconnected state. Alternatively, the first controller portion 132 automatically activates the braking device and stops the traveling device 7 even when the brake pedal is not operated. Alternatively, the first controller portion 132 automatically stops the driving of the prime mover 4. In addition, the first controller portion 132 automatically stops the tilling device 2 (the working device) by outputting an electric signal (a control signal) to the PTO clutch to switch the PTO clutch from the connected state to the disconnected state.

FIG. 8B is a diagram illustrating a first modified example of the flowchart showing the operation support for the tractor. The steps S101 to S106 shown in FIG. 8B are the same as those in FIG. 8A.

As shown in FIG. 8B, when the distance difference Ln is equal to or less than the threshold value M1 (step S106, Yes), the first controller portion 132 controls the operation device 11 of the tractor 1 (step S108). For example, when the operator is not awake, the first controller portion 132 automatically outputs sounds or the like from the display device 120c that is one of the control devices 11 to urge the operator to wake up. When the operator is in the bad physical condition, the first controller portion 132 automatically operates the headlight switch of the operation device 11 to light the headlamp by switching the headlamp, and thereby informing other operators around the tractor 1 and the like that the operator is in the bad physical condition.

The support system for the agricultural machine described above is provided with the control device 120d for controlling the agricultural machine 1 based on the vital data detected by the biological condition detector device 123, the machine position detected by the position detector device 122, and the agricultural field information. Thus, the state of the operator at the time of agricultural operation can be known by the biological condition detector device 123 based on the vital data, and the agricultural operation can be performed while controlling the agricultural machine 1 according to the state of the operator.

The control device 120d includes a first calculator portion 131 and a first controller portion 132. First, the first calculator portion 131 can grasp a distance difference between the agricultural machine 1 and the boundary of agricultural field, that is, can grasp how far the agricultural machine 1 separates from the bank of the agricultural field while traveling and performing the agricultural operation. And, the first control portion 132 can control the agricultural machine 1 appropriately, referring to the distance (the distance difference) between the agricultural machine 1 and the bank of agricultural field and to a operator's biological condition.

For example, the first controller portion 132 stops the agricultural machine 1 when the distance difference is equal to or smaller than the threshold value and when the vital data indicates that the operator is not awake or is in the bad physical condition. That is, in the state where the agricultural machine 1 is traveling or performing the working at a position close to the bank of the agricultural field, the traveling and operation of the agricultural machine 1 can be automatically stopped when the operator is not awake and is sleepy or the operator is in the bad physical condition.

In addition, the first control portion 132 controls the control device of the agricultural machine 1 when the distance difference is equal to or less than a threshold value and the vital data represents that the operator is not awake or is in the bad physical condition. For example, when the operator is not awakened, the control device is controlled to generate sounds, thereby prompting the operator to be awakened, the control device notifies the abnormality of operator to the surroundings by controlling to light the headlamp of the agricultural machine 1, or the control device is controlled to turn the agricultural machine, thereby preventing the agricultural machine from approaching the bank of the agricultural field.

### Third Embodiment

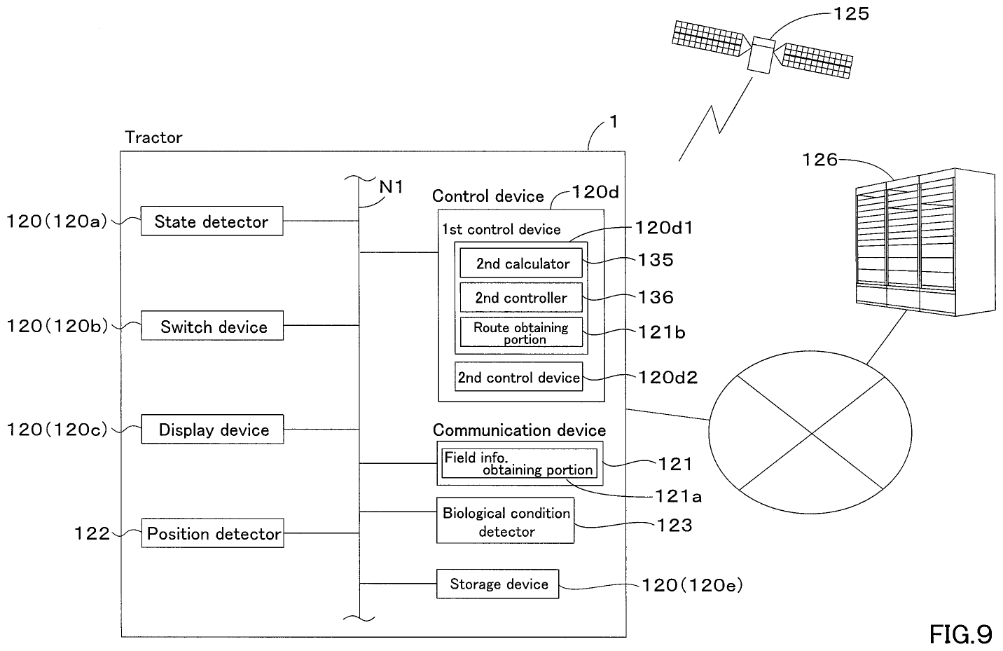

FIG. 9 shows an operation support system for the agricultural machine according to a third embodiment of the present invention. The operation support system for the agricultural machine according to the third embodiment is a system that controls the tractor 1 based on a predetermined scheduled traveling route instead of the agricultural field position shown in the second embodiment. Configurations different from the first embodiment and the second embodiment will be described.

As illustrated in FIG. 9, the first control device 120d1 includes a route obtaining portion 121b that obtains a scheduled traveling route. The route obtaining portion 121b is constituted of an electric/electronic component provided in the communication device 121, a computer program incorporated in the communication device 121, or the like.

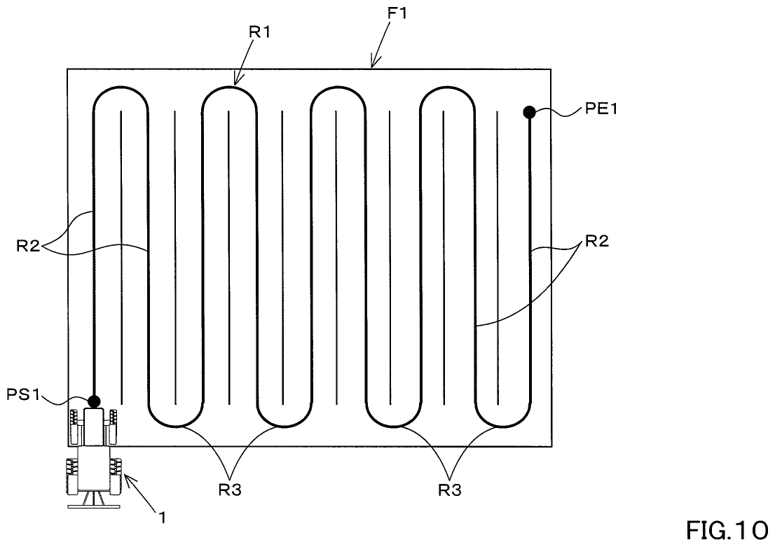

FIG. 10 shows an example of a scheduled traveling route R1. The scheduled traveling route R1 will be described below. The scheduled traveling route R1 is set by the display device 120c mounted on the tractor 1 or by the support device 126 such as a mobile terminal.

In addition, in order to set the scheduled traveling route R1, the agricultural field F1 in which the tractor 1 performs the working is displayed on the display portion of the support device 126. The scheduled traveling route R1 for the tractor 1 is inputted to the agricultural field F1 displayed on the display portion of the support device 126. For example, in the agricultural field F1, the traveling start position PS1, the traveling end position PE1, and the scheduled traveling route R1 from the traveling start position PS1 to the traveling end position PE1 are set for the tractor 1 with use of the interface or the like of the support device 126. The scheduled traveling route R1 shown in FIG. 10 includes a straight traveling portion R2 on which the tractor moves straight and a turning portion R3 on which the tractor 1 turns. In the setting of the scheduled traveling route R1, in the agricultural field F1 displayed on the display portion, the traveling start position PS1, the traveling end position PE1, the straight travel portion R2, and the turning portion R3 are associated with the positions (latitude, longitude) respectively, and by determining at least the positions corresponding to the traveling start position PS1, the traveling end position PEI, the straight travel portion R2, and the turning portion R3 on the display portion of the support device 126, the scheduled traveling route R1 can be set. The positions corresponding to the traveling start position PS1, the traveling end position PE1, the straight traveling portion R2, and the turning portion R3 are stored as traveling information in the support device 126. In the setting of the scheduled traveling route R1, the route may be divided into predetermined sections, and the forward traveling or the backward traveling may be assigned to each of the sections. The setting of the scheduled traveling route R1 shown in FIG. 10 is an example, and is not restricted to the example as a matter of course.

The route obtaining portion 121b requests the support device 126 for the scheduled traveling route R1, that is, the traveling information through the communication device 121. The support device 126 transmits the traveling information stored in the support device 126 from the support device 126 to the communication device 121 by wireless or the like in response to a request from the route obtaining portion 121b. The route obtaining portion 121b obtains the traveling information when the communication device 121 receives the traveling information, and stores the obtained traveling information in the storage device 120e. In the embodiment, the scheduled traveling route R1 is obtained through the communication device 121. However, when the scheduled traveling route R1 is set on the display device 120c or the like, the scheduled traveling route R1 may be is requested to and obtained from the display device 120c.

As shown in FIG. 9, the first control device 120d1 controls the tractor 1 based on the scheduled traveling route R1, the machine position detected by the position detector device 122, and the vital data detected by the biological condition detector device 123. In particular, the first control device 120d1 includes a second calculator portion 135 and a second controller portion 136. The second calculator portion 135 and the second controller portion 136 are constituted of electrical/electronic components provided in the first control device 120d1, computer programs installed in the first control device 120d1, or the like.

The second calculator portion 135 calculates the traveling position of the tractor 1 with respect to the scheduled traveling route R1 based on the machine position Pn and the scheduled traveling route R1. The traveling position is a position indicating where the current tractor 1 is currently located on the route with respect to the scheduled traveling route R1. For example, when the machine position Pn is substantially the same as the traveling start position PS1, the traveling position is the traveling start position PS1, and when the machine position Pn is substantially the same as the traveling end position PE1, the traveling position is the traveling end position PE1. In addition, when the machine position Pn is substantially coincident with the straight traveling portion R2 of the scheduled traveling route R1, the traveling position is the straight traveling portion R1, and when the machine position Pn is approximately coincident with the turning portion R3 of the scheduled traveling route R1, the traveling position is the turning portion R3. The second controller portion 35 controls the tractor based on the vital data and the traveling position.

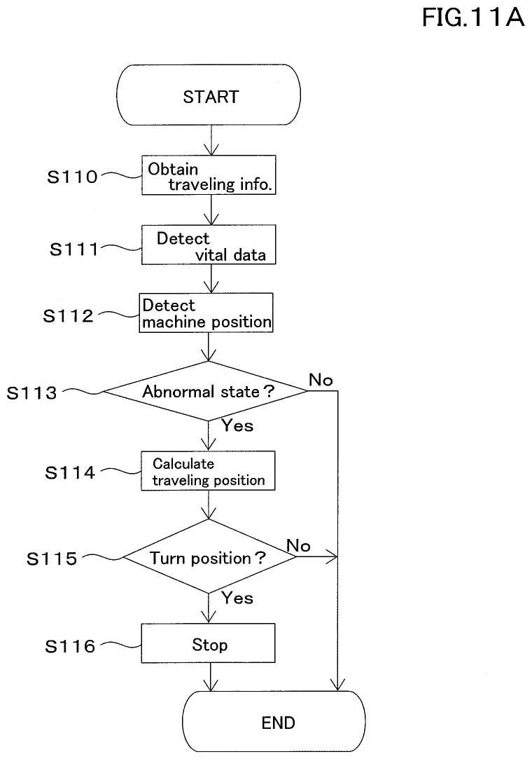

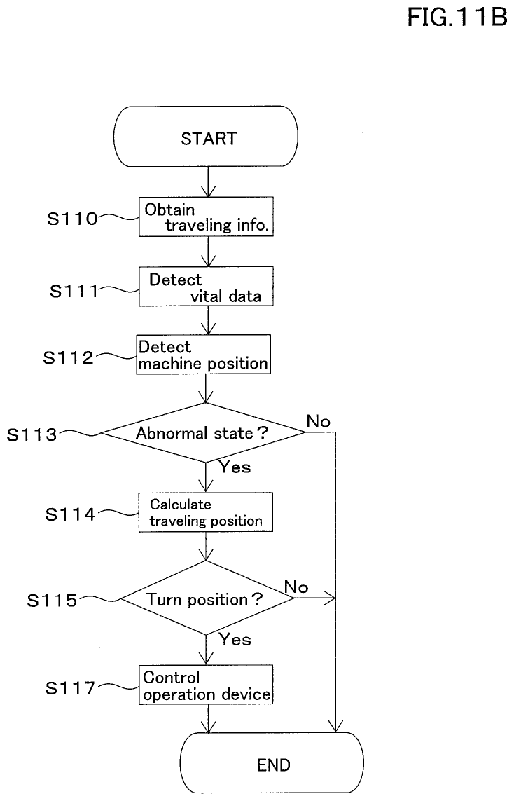

FIG. 11A shows a flowchart showing an operation support for the tractor according to the second embodiment. As shown in FIG. 11A, the scheduled traveling route R1 (the traveling information) is obtained by the route obtaining portion 121b before the tractor 1 is started (before the traveling) (step S110). After the prime mover 4 of the tractor 1 stars, the vital data is detected by the biological condition detector device 123 (step S111), and the mechanical position Pn is detected by the position detector device 122 (step S112).

In addition, after starting the prime mover 4 of the tractor 1, the second controller portion 136 judges whether or not the operator is in the abnormal state (the abnormal condition) based on the vital data detected by the biological condition detector device 123 (step S113). Here, the judgment of the abnormal state in the second controller portion 136 is the same as that of the first controller portion 131, and thus the description thereof is omitted.

When the operator is in the abnormal state (step S113, Yes), the second calculator portion 135 calculates the traveling position of the tractor 1 with respect to the scheduled traveling route R1 based on the scheduled traveling route R1 and the machine position Pn detected by the position detector device 122 (step S114). For example, the second calculator portion 135 compares the current machine position Pn to the scheduled traveling route R1 to determine the traveling position on the scheduled traveling route Rl. When the current machine position Pn is at a position corresponding to the straight traveling portion R2 of the scheduled traveling route R1, the second calculator portion 135 determines that the traveling position is on the straight traveling position. In addition, when the current machine position Pn is at a position corresponding to the turning portion R3 of the scheduled traveling route R1, the second calculator portion 135 determines that the traveling position is on the turning position.

After the calculation of the traveling position by the second calculator portion 135 (after step S114), the second controller portion 136 of the first control device 120d1 judges whether or not the current traveling position is in the turning position (step S115). That is, the second controller portion 136 judges whether or not the tractor 1 is approaching the place where the tractor 1 turns.

When the traveling position of the tractor 1 is the turning position (step S115, Yes), that is, when the traveling position indicates at least the turning position of the scheduled traveling route R1 and when the vital data indicates that the operator is not awake or in the bad physical condition, the second controller portion 136 stops the tractor 1 (step S116). That is, the second controller portion 136, as in the first controller portion 131, ignores the operation amount of the accelerator pedal and the shift lever position (the shift position) even when the traveling is ordered based on the operation amount of the accelerator pedal and based on the shift lever position (the shift position). For example, the second controller portion 136 stops the traveling device 7 by outputting an electric signal (a control signal) to the traveling clutch to switch the traveling clutch from the connected state to the disconnected state. Alternatively, the second controller portion 136 automatically activates the braking device and stops the traveling device 7 even when the brake pedal is not operated. Alternatively, the second controller portion 136 automatically stops the driving of the prime mover 4. In addition, the second controller portion 136 automatically stops the tilling device 2 (the working device) by outputting an electric signal (a control signal) to the PTO clutch to switch the PTO clutch from the connected state to the disconnected state.

FIG. 11B is a view illustrating a modified example of the flowchart showing the operation support for the tractor according to the second embodiment. Steps S110 to S115 shown in FIG. 11B are the same as those in FIG. 11A.

As shown in FIG. 11B, when the traveling position of the tractor 1is on the turming position (step S115, Yes), the second controller portion 136 controls the operation device 11 of the tractor 1 (step S117). For example, when the operator is not awake, the second controller portion 132 automatically outputs sounds or the like from the display device 120c that is one of the control devices 11 to urge the operator to wake up. When the operator is in the bad physical condition, the second controller portion 136 automatically operates the headlight switch of the operation device 11 to light the headlamp by switching the headlamp, and thereby informing other operators around the tractor 1 and the like that the operator is in the bad physical condition.

According to that, the support system for the agricultural machine 1 described above is provided with the control device 120d that controls the agricultural machine based on the scheduled traveling route R1, the vital data detected by the biological condition detector device 123, and the machine position detected by the position detector device 122. For example, when the scheduled traveling route R1 for the agricultural machine 1 is determined regardless of whether it is the manual traveling or the automatic traveling, the agricultural machine 1 can be controlled based on the condition of the operator (the vital data) and the machine position (the traveling position) with respect to the scheduled traveling route Rl.

The control device 120d includes the second calculator portion 135 and the second controller portion 136. Thus, the second calculator portion 135 is capable of knowing the machine position (the traveling position) of the agricultural machine 1 with respect to the scheduled traveling route R1. And, the second controller portion 136 is capable of appropriately controlling the agricultural machine 1 while watching at the traveling position with respect to the scheduled traveling route R1 and the condition of the operator.

For example, the second controller portion 136 stops the agricultural machine when the traveling position indicates at least the turning position on the scheduled traveling route R1 and the vital data indicates that the operator is not awake or is in the bad physical condition. That is, when the operator is not awake sleepy or is in the bad physical condition under the state where the agricultural machine 1 travels on the turning position determined by the scheduled traveling route R1, the traveling or working of the agricultural machine 1 can be automatically stopped.

The second controller portion 136 controls the operation device of the agricultural machine 1 when the traveling position indicates at least the turning position on the scheduled traveling route and the vital data indicates that the operator is not awake or is in the bad physical condition.

For example, under the state where the agricultural machine 1 travels on the turning position determined by the scheduled traveling route R1, when the operator is not awakened, the control device is controlled to generate sounds, thereby prompting the operator to be awakened, the control device notifies the abnormality of operator to the surroundings by controlling to light the headlamp of the agricultural machine 1, or the control device is controlled to turn the agricultural machine, thereby preventing the agricultural machine from approaching the bank of the agricultural field.

### Fourth Embodiment

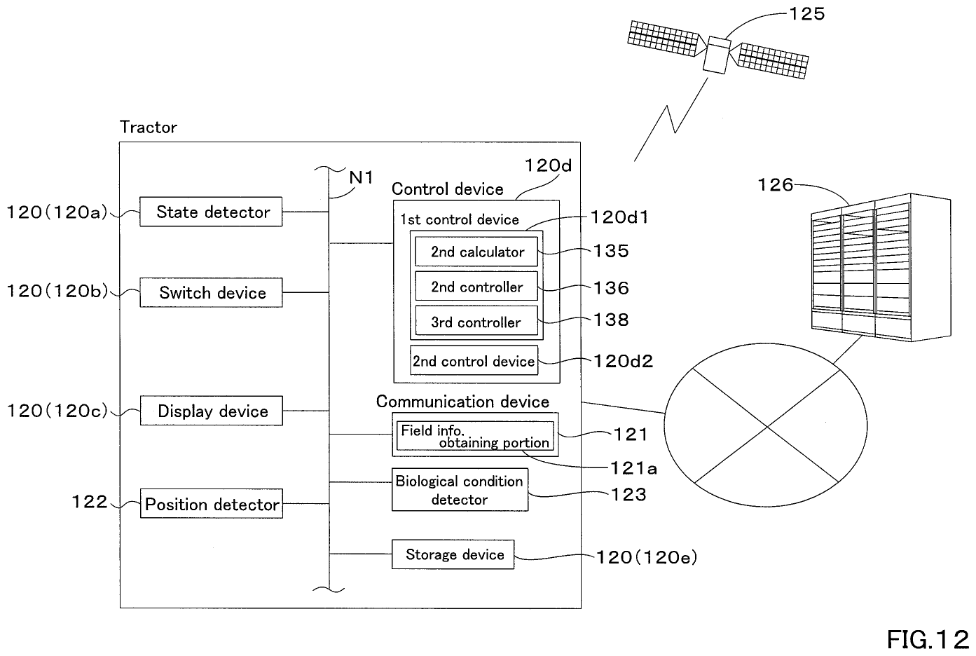

FIG. 12 shows an operation support system for an agricultural machine according to a fourth embodiment of the present invention. The operation support system for the agricultural machine according to the fourth embodiment is a system that automatically travels the tractor 1 based on a scheduled traveling route. Configurations different from the configurations according to the first embodiment to the third embodiment will be described below.

The first control device 120d1 has a third controller portion 138. The third controller portion 138 is constituted of an electric/electronic component provided in the first control device 120d1, a computer program incorporated in the first control device 120d1, or the like. The third controller portion 138 is a device that controls the automatic traveling of the tractor 1 based on the scheduled traveling route R1. The third controller portion 138 controls the operation device or the like that is capable of changing the traveling direction of the vehicle body 2 based on various information detected by the position detector device 122, and performs the automatic traveling.

When the automatic traveling of the tractor 1 is performed, the third controller portion 138 refers to a position (a target position) indicated by the traveling information, and controls the operation device such that a position (a detected position) detected by the position detector device 122 is matched with the position (the target position) indicated in the traveling information. For example, when the target position is matched with the detected position and when the tractor 1 is traveling on the straight traveling portion R2 indicated on the scheduled traveling route R1, the third controller portion 138 maintains the steering angle at zero. In addition, when the target position is matched with the detected position and when the tractor 1 is traveling on the turning portion R3 indicated by the scheduled traveling route R1, the third controller portion 138 controls the steering angle of the steering device to coincide with an angle at the turning portion R3. In addition, when there is a predetermined deviation or more between the detection position and the target position, the third controller portion 138 controls the steering device so that there is no deviation, thereby correcting the traveling position of the tractor 1. When the forward traveling or the backward traveling is indicated on the scheduled traveling route R1, the third controller portion 138 controls the transmission device 4 to switch the traveling of the tractor 1 between the forward traveling and the backward traveling.

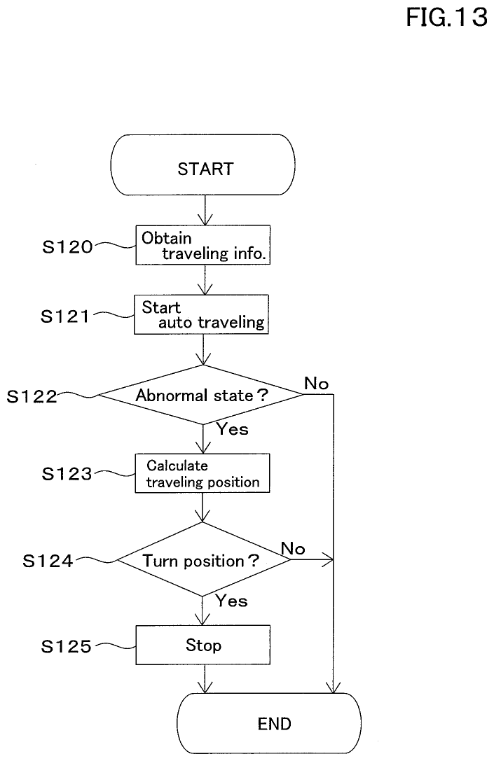

FIG. 13 is a view illustrating a flowchart showing the operation support for the tractor according to the fourth embodiment. In FIG. 13, the description will be made assuming that vital data and the machine position information are obtained during the automatic traveling of the tractor 1.

As shown in FIG. 13, the scheduled traveling route R1 (the traveling information) is obtained by the route obtaining portion 121b before the tractor 1 automatically travels (step S120). After the automatic traveling of the tractor 1 by the third controller portion 138 is started (step S121), the second controller portion 136 judges whether or not the operator is in the abnormal state (the abnormal condition) based on the vital data detected by the biological condition detector device 123 during the control of the automatic traveling by the third controller portion 138 (step S122). The judgment of the abnormal state by the second controller portion 136 is the same as that of the first controller portion 131.

When the operator is in the abnormal state (step S122, Yes), the second calculator portion 135 calculates the traveling position of the tractor 1 with respect to the scheduled traveling route R1 based on the scheduled traveling route R1 and the machine position Pn detected by the position detector device 122 (step S123). For example, after the second calculator portion 135 calculates the traveling position (after the step S123), the second calculator portion 135 compares the current machine position Pn to the scheduled traveling route R1 to judge whether the current traveling position is on the turning position (step S124). When the traveling position of the tractor 1 is on the turning position (step S124, Yes), that is, when the traveling position indicates at least the turning position of the scheduled traveling route R1 and when the vital data indicates that the operator is not awake or is in the bad physical condition, the second controller portion 136 stops the tractor (step S125). For example, the second controller portion 136 stops the tractor 1 with priority over the traveling by the third controller portion 138. The second controller portion 136 stops the automatic traveling control by the third controller portion 138, and stops the traveling device 7 or the working device 2 in the same manner as that of the first controller portion 131.

The control device 120d includes the third controller portion 138 that controls the traveling of the agricultural machine 1 based on the scheduled traveling route R1, and the second controller portion 136 stops the agricultural machine 1 with priority over the traveling by the third controller portion 138. In this manner, the control by the second controller portion 136 is prioritized over the automatic travel control by the third controller portion 138. For this reason, even under the state where the agricultural machine 1 is in the automatic traveling state, the agricultural machine 1 can be stopped when an abnormality of the operator is detected.

### Fifth Embodiment

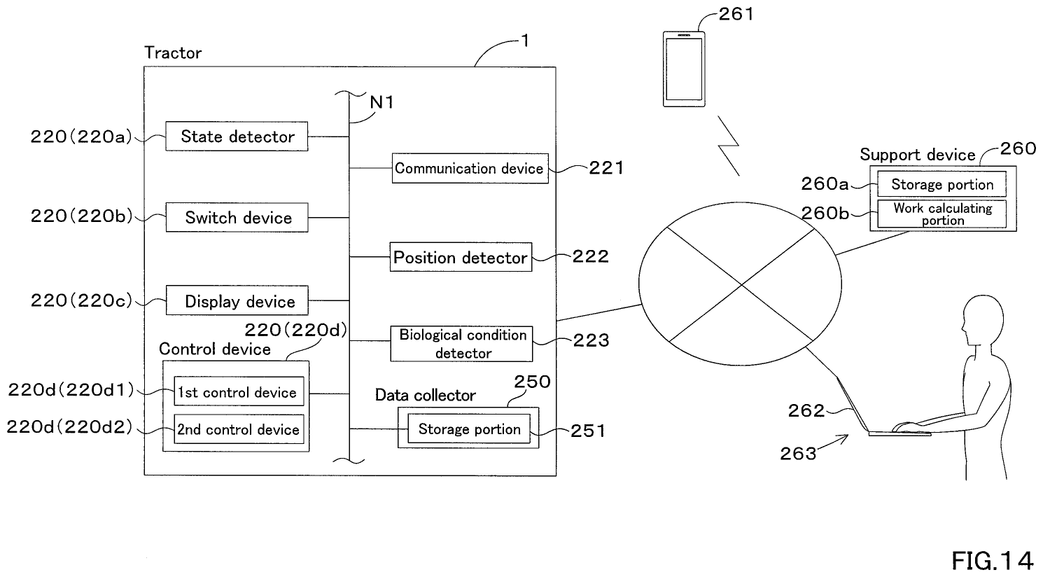

FIG. 14 is a view showing an agricultural support system according to a fifth embodiment of the present invention. The agricultural support system is a system capable of supporting agricultural workings. In the fifth embodiment, configurations different from those of the first embodiment to fourth embodiment will be described below.

As shown in FIG. 14, the tractor 1 is provided with a plurality of devices 220. The plurality of devices 220 are connected by an in-vehicle network N1 such as the CAN, the LIN, or the FlexRay. The devices 220 constitute the tractor 1, and includes, for example, a state detector device 220a, a switch device 220b, a display device 220c, and a control device 220d.

The state detector device 220a is a detecting device that detects the state (the machine state) of the tractor 1. The state detector device 220a is an accelerator pedal sensor, a shift lever detector sensor, a crank position sensor, a fuel sensor, a water temperature sensor, an engine revolving sensor, a steering angle sensor, an fluid temperature sensor, an axle rotation sensor, and the like. The switch device 220b is a device that performs the switching, and is an ignition switch, a parking brake switch, a PTO switch, or the like. The display device 220c is a device that displays various items related to the tractor 1, and is a liquid crystal display device constituted of liquid crystal or the like.

The control device 220d includes a first control device 220d1 and a second control device 220d2. The first control device 220d1 is a device that controls a whole of the tractor 1. The first control device 220d1 receives a detection value detected by the state detector device 220a [for example, an operation amount of the accelerator pedal detected by the accelerator pedal sensor, a shift lever position(a shift position) detected by the shift lever in operating the shift lever, an engine revolving speed detected by the engine revolving sensor, a fluid temperature detected by the fluid temperature sensor, a crank position detected by the crank position sensor, and the like]. The first control device 220d1 outputs a control command to the second control device 220d2 based on the operation amount of the accelerator pedal such that the engine is driven at a predetermined revolving speed, and controls the transmission device 5 (the shift control) based on the shift lever position. In addition, the first control device 220d1 controls the raising/lowering of the coupling portion 8 based on an input from the operation member (an elevation control).

The second control device 220d2 is a device that mainly controls the engine 4. The second controller 220d2 controls an injector, a common rail, a supply pump, and the like based on the inputs such as the operation amount of the accelerator pedal, the crank position, the cam position, and the like. In the engine control of the second control device 220d2, for example, the fuel injection amount, the injection timing, and the fuel injection rate are set in the control of the injector, and the fuel injection pressure is set in the control of the supply pump and the control of the common rail.

The agricultural support system includes the communication device 221, the position detector device 222, and the biological condition detector device 223. The communication device 221 and the position detector device 222 are provided in the tractor 1 and are connected to the in-vehicle network N1.

The communication device 221 is a device that outputs data (information) of the tractor 1 to the outside of the tractor 1 and obtains external data into the tractor 1. The communication device 221 performs the wireless communication in accordance with, for example, IEEE 802.11 series Wi-Fi (Wireless Fidelity, a registered trademark), which is a communication standard, or wirelessly using a mobile phone communication network, a data communication network, a mobile phone communication network, or the like.

The position detector device 222 is a detector device that is capable of detecting the position of the tractor 1, and is a device that detects a position (latitude, longitude) based on a satellite signal (a radio wave) of a positioning satellite, for example. That is, the position detector device 222 detects the position of the vehicle body 3 with use of a satellite positioning system (the Global Positioning System, the Galileo, the GLONASS, etc.). The position detector device 222 is attached to the top plate of the cabin 12, for example. The position detector device 222 may be attached to a portion other than the cabin 12, and may be provided in the working device 2, for example. Hereinafter, for convenience of the explanation, the position (latitude, longitude) detected by the position detector device 222 is referred to as a “machine position”. The machine position detected by the position detector device 122 is stored in the storage portion 251 described below.

The biological condition detector device 223 is a device that detects the vital data of the operator. The biological condition detector device 223 is, for example, a sensor or an electrode that measures the vital data such as an operator's heartbeat, breathing, sleeping, body temperature, sweating, body posture (body movement), electromyogram (muscle movement), and the like. In addition, the biological condition detector device 223 is a wearable device attached to the operator, or is a non-wearable device provided around the operator seat 10. When the biological condition detector device 223 is the wearable device, the vital data detected by the biological condition detector device 223 is transmitted to the communication device 221 through a wireless device stored in the biological condition detector device 223. When the biological condition detector device 223 is the non-wearable device, the biological condition detector device 223 is connected to the in-vehicle network N1, and the vital data detected by the biological condition detector device 223 is transmitted to the in-vehicle network N1. In FIG. 14, the biological condition detector device 223 of wearable type is shown.

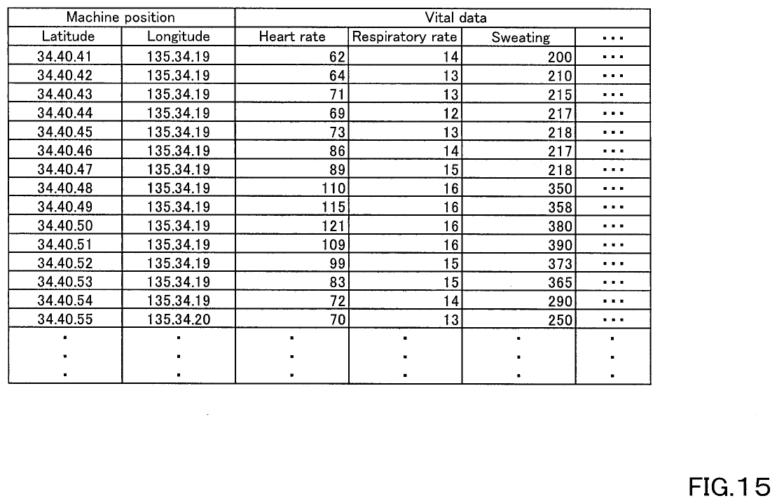

As described above, since the agricultural support system includes the position detector device 222 and the biological condition detector device 223, the machine position detected by the position detector device 222 and the vital date detected by the biological condition detector device 223 are associated with each other and obtained as shown in FIG. 15.

Now, the tractor 1 includes a data collecting device 250. The data collecting device 250 is connected to the in-vehicle network N1. The data collecting device 250 is a device that is capable of collecting various data (operation information) generated when the tractor 1 (the working device 2) is operated, for example.

When the agricultural working is performed by the tractor 1 (the working device 2), the data collecting device 250 collects, for example, the remaining amount of fuel obtained by the fuel detector sensor, the number of operations of the shuttle lever (the number of times of switching), the number of times of turning the handling wheel (the number of times of turning the steering wheel) as the operation information. It should be noted that the number of shuttle lever operations, the number of steering wheel turnings, and the remaining amount of fuel can be detected by a sensor or the like. In addition, the number of shuttle lever operations, the number of steering wheel turnings, and the remaining amount of fuel are inputted to the operation device 11 or outputted to the in-vehicle network N1. Thus, the data collecting device 250 can collect the number of shuttle lever operations, the number of steering wheel turnings, and the remaining amount of fuel by making a request to the operation device 11 or directly obtaining the data flowing in the in-vehicle network N1.

The data collecting device 250 collects the operation information corresponding to the work device 2. For example, when the work device 2 is a tilling device, the data collecting device 250 collects the rotary revolving speed, the rotary load, the engine revolving speed, the tilling depth, the tilling width, and the like as the operation information. When the work device 2 is a fertilizer spraying device, an agricultural chemicals spraying device, or a seeding dispersing device, the data collecting device 250 collects, as the operation information, the spraying amounts (a fertilizer spraying amount, an agricultural chemicals spraying amount, a seed dispersing amount) and spraying width.

The data collecting device 250 collects the machine position detected by the position detector device 222. That is, the data collecting device 250 collects the positions (latitude and longitude) sequentially detected by the position detector device 222.

In addition, the data collecting device 250 is configured to obtain the vital data detected by the biological condition detector device 223. For example, when the biological condition detector device 223 is the wearable type, the data collecting device 250 obtains the vital data received from the biological condition detector device 223 by the communication device 221 together with the operation information. In addition, when the biological condition detector device 223 is the non-wearable type and is provided in the tractor 1, the data collecting device 250 obtains the vital data transmitted to the in-vehicle network N1 together with the operation information.

The operation information, the machine position, and the vital data collected by the data collecting device 250 are temporarily stored in the storage portion 251 provided in the data collecting device 250. The operation information and the vital data stored in the storage portion 251 can be transmitted to the outside through the communication device 221.

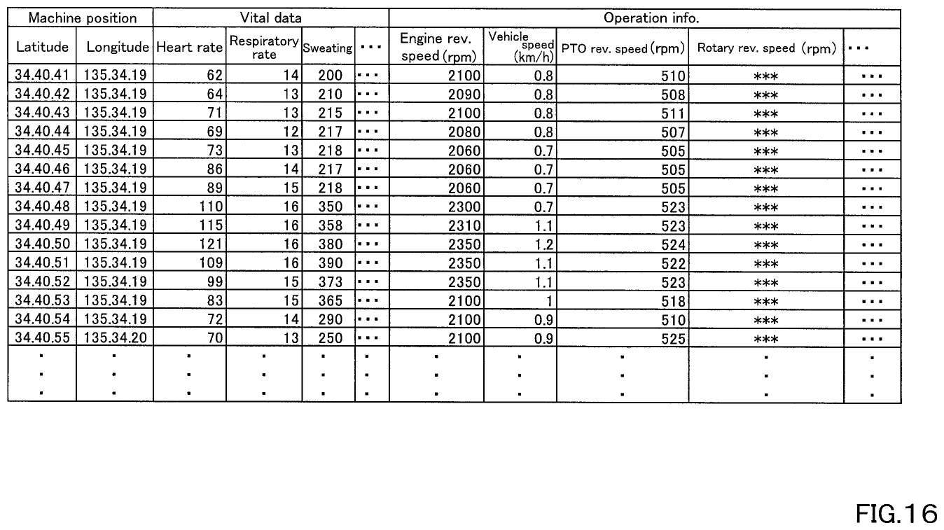

FIG. 16 shows the operation information, the machine position, and the vital data obtained by the data collecting device 250. As shown in FIG. 16, the vital data of the operator generated when the tractor 1 is operated can be obtained sequentially.

The vital data preferably includes personally-identifying information for identifying the operator. For example, when the biological condition detector device 223 is the wearable type, the biological condition detector device 223 is attached to a specific operator, and thus the identification information of the biological condition detector device 223 serves as the personally-identifying information. In addition, when the biological condition detector device 223 is the non-wearable type and is attached to the tractor 1, for example, an operator inputs the personally-identifying information to the display device 220c or the like when getting on, or transmits the personally-identifying information to the communication device 221 with use of the mobile terminal 261 or the like. In this manner, it is possible to specify which operator is related to the obtained vital data the time when the data collecting device 250 obtains the vital data.

In the embodiment described above, an example has been described in which the operator can be specified at the time when the data collecting device 250 obtains the vital data and the operation information, but the present invention is not limited to that configuration. For example, after the data collecting device 250 collects the vital data that does not have the personally-identifying information, the communication device 221 transmits, to the mobile terminal 261 possessed by the operator, the operation information together with the vital data that does not have personally-identifying information. After that, after the mobile terminal 261 receives the operation information and the vital data that do not have the personally-identifying information, the personally-identifying information of the operator assigned to the mobile terminal 261 may be associated with the received vital data and the received operation information, and thereby the vital data may include personally-identifying information.

According to the above configuration, the data collecting device 250 is capable of collecting the operation information generated when the agricultural working is performed by the tractor 1 and the vital data of the operator, and thus the state of operator performing the agricultural working can be known based on the operation information and the vital data.

Now, as shown in FIG. 14, the agricultural support system includes a support device 260. The support device 260 is a server or the like that is capable of communicate with the communication device 221 of the tractor 1. The support device 260 is capable of communicating with the communication device 221 regularly or irregularly, and is capable of obtaining the operation information, the machine position (the machine position information), and the vital data transmitted from the communication device 221. In this embodiment, the support device 260 receives the operation information, the machine position, and the vital data through the direct communication between the communication device 221 and the support device 260. However, the support device 260 may receive the operation information, the machine position, and the vital data through the indirect communication. In that case, the agricultural support system includes, for example, a mobile terminal 261 assigned to the operator. That is, the mobile terminal 261 is possessed by an operator who boards on the tractor 1, and is a smartphone (a multifunctional mobile phone), a tablet PC, or the like having a relatively high computing ability. The mobile terminal 261 can wirelessly communicate with both the communication device 221 and the support device 260. The wireless communication may be performed in accordance with, for example, IEEE802.11 series Wi-Fi (Wireless Fidelity (a registered trademark)) which is a communication standard through a mobile phone communication network, a data communication network, or the like.

Thus, when the agricultural support system includes the mobile terminal 261, the mobile terminal 261 receives and obtains the operation information, the machine position, and the vital data transmitted from the communication device 221, and then transmits the operation information, the machine position, and the vital data to the support device 260. In this manner, the support device 260 can receive the operation information, the machine position, and the vital data through the mobile terminal 261.

The support device 260 includes a storage portion 260a and a working calculator portion 260b. The storage portion 260a is constituted of a non-volatile memory or the like, and stores the operation information, the machine position, and the vital data received by the support device 260. The working calculator portion 260b calculates the agricultural working based on the operation information. The working calculator portion 260b is constituted of an electric/electronic component provided in the support device 260, a computer program incorporated in the support device 260, or the like.

The working calculator portion 260b calculates the agricultural working based on the operation information and items of the agricultural working stored in advance in the storage portion 260a. For example, when the operation information includes the number of rotations of the rotary, the load of the rotary, the tilling width, and the like, the working calculator portion 260b determines that the agricultural working is the “cultivation”. When the operation information includes the spraying amount and the spraying width, the working calculator portion 260b determines that the agricultural working is the “spraying”. In addition, when the operation information includes the identification information (a machine type, a model number, model, and the like) for identifying the working device 2, for example, when the identification information of each of the tillage device, the fertilizer application device, the agricultural chemicals spraying device, and the seed dispersing device is included, it is determined that the agricultural workings are the “cultivation”, the “fertilization”, the “agricultural chemicals application”, the “seeding”.

The agricultural support system includes a display device 262. The display device 262 is a device that displays information related to the vital data detected by the biological condition detector device 223 and information related to the operation information collected by the data collecting device 250. The display device 262 is included in a computer (a terminal) 263 configured to be connected to the support device 260. The computer (the terminal) 263 is, for example, a personal computer (PC) assigned to an administrator who manages the operators. The computer (the terminal) 263 may be the mobile terminal 261 described above.

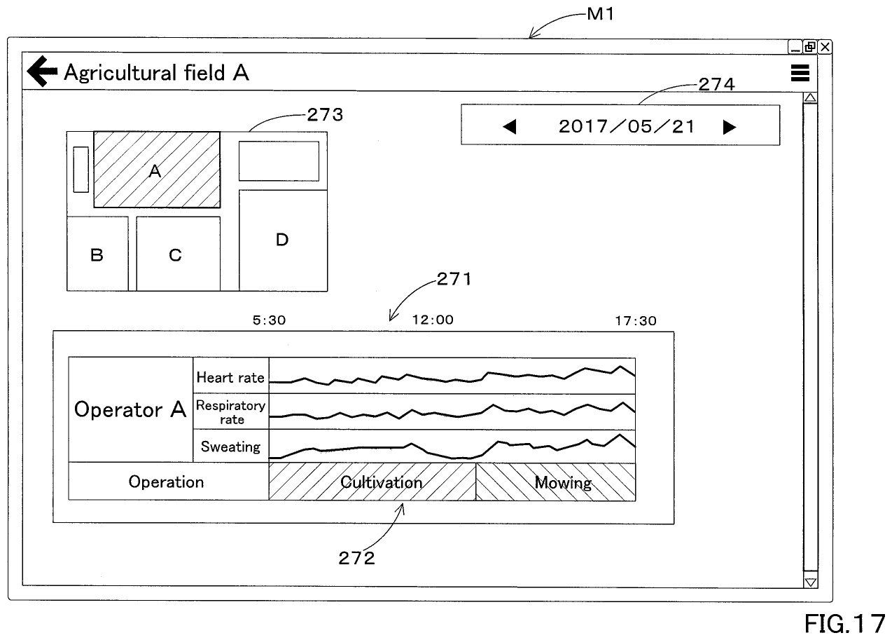

When the computer 263 requests display of the agricultural working after the computer (the terminal) 263 logs in to the support device 260, the support device 260 displays a working display screen M1 on the display device 262 of the computer 263 as shown in FIG. 17. The working display screen M1 is a screen that displays information related to the vital data and information related to the operation information. The working display screen M1 includes a biological condition display portion 271 that displays the vital data, a working display portion 272 that displays the agricultural work, an agricultural field display portion 273 that displays agricultural fields, and a date display portion 274 that displays dates. The agricultural field display portion 273 displays information for specifying an agricultural field, such as an agricultural field map and an agricultural field name registered in advance in the support device 260. In the date display portion 274, the date (year, month, day) is displayed. When a predetermined field is selected from the agricultural field map displayed on the agricultural field display portion 273 and a predetermined date displayed on the date display portion 274 is selected on the working display screen M1, the biological condition display portion 271 displays the name of operator who performed the working on the selected agricultural field (the selected field) at the set date (the selected date) and displays the vital data (the heart rate, the breathing, the body temperature, the sweating) generated when the operator performed the working with use of characters, numerical values, figures and the like. In addition, the working display portion 272 displays an agricultural working name indicating the agricultural working performed on the selected agricultural field.

In particular, after the support device 260 displays the working display screen M1 on the display device 262 of the computer (the terminal) 263, the support device 260 refers to the storage portion 260a, calculates the agricultural field using the machine position corresponding to the selected date as a key, and calculates the operator using, as a key, the personally-identifying information included in the vital data associated with the machine position and the like, and then the operator name and the vital data corresponding to the operator name are displayed on the biological condition display portion 271. In addition, the working calculator portion 260b of the support device 260 refers to the storage portion 260a, calculates the agricultural working using the operation information corresponding to the selected date and the selected agricultural field, and sequentially displays the agricultural working names corresponding to the calculated agricultural workings. In the above-described embodiment, the agricultural working is calculated from the operation information. Alternatively, the operation of the agricultural machine may be calculated from the operation information, and the relation between the operation and the vital data may be displayed. For example, it is judged from the operation information whether the steering is turned, whether the engine revolving speed is changed by pressing the accelerator, or whether the coupling portion 8 is moved upward or downward. The, the relation between the operation of the agricultural working machine and the vital data may be displayed on the working display portion 272.

Thus, the agricultural support system includes the biological condition detector device 223, the data collecting device 250, and the display device 262, and displays the vital data detected by the biological detector device and the operation information collected by the data collecting device 250. Thus, the operation information obtained when the agricultural machine is operated can be associated with the operator's vital data. For example, it is possible to grasp the relation between the agricultural working by the agricultural machine obtained from the operation information of the agricultural machine and the state of the operator. Alternatively, it is possible to grasp the relation between the operation of the agricultural machine obtained from the operation information of the agricultural machine and the state of the operator.

in addition, the agriculture support system includes a working calculator portion 260b. Thus, the contents of the agricultural working can be calculated from the operation information of the agricultural machine. In this manner, the contents of the agricultural working and the vital data of the operator can be associated with each other without sequentially inputting of the contents of the agricultural working.

In the above-described embodiment, the display device 262 is included in the computer (the terminal) 263, but may be included in the mobile terminal 261.

### Sixth Embodiment

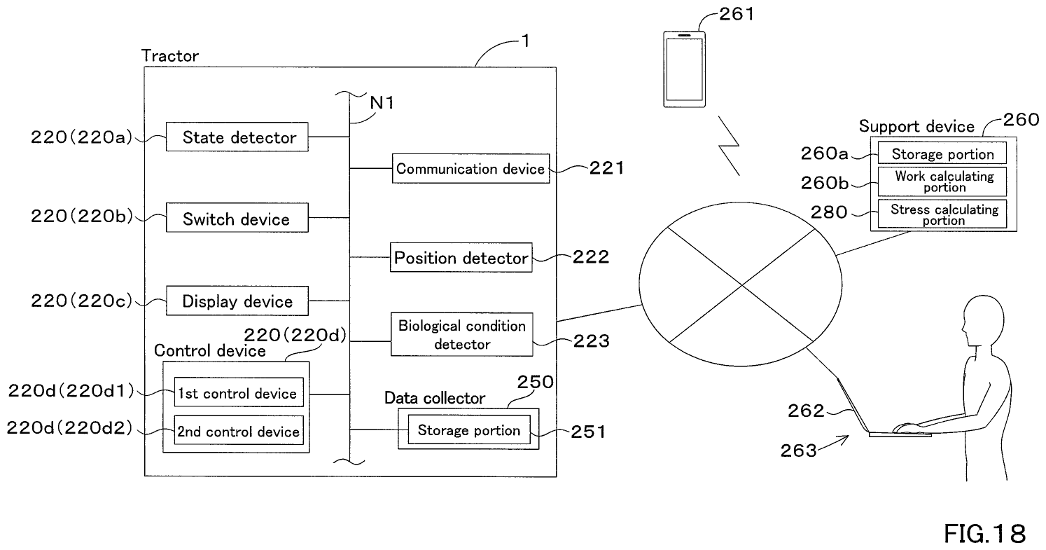

FIG. 18 shows an agricultural support system according to a sixth embodiment of the present invention. In the sixth embodiment, configurations different from those of the first embodiment to the fifth embodiment will be described.

The support device 260 includes a stress calculator portion 280. The stress calculator portion 280 is constituted of an electric/electronic component provided in the support device 260, a computer program incorporated in the stress calculator portion 280, or the like. The stress calculator 280 calculates the stress value of the operator based on the vital data. For example, the stress calculator portion 280 obtains a stress value based on the heart rate, the respiration, the body temperature, the sweating, and the like included in the vital data. The stress calculator portion 280 sets in advance standard values of the heart rate, the breathing, the body temperature, the sweating, and the like in the normal condition (when the body is not moving) in advance for each operator, and obtains the stress value depending on whether they are higher or lower than the standard values. For example, when the values of the items (the heart rate, the respiration, the body temperature, the sweating) indicated by the vital data is higher than the standard values, the stress value is high, and when the values of the items are equal to or lower than the standard values, the stress value is low.

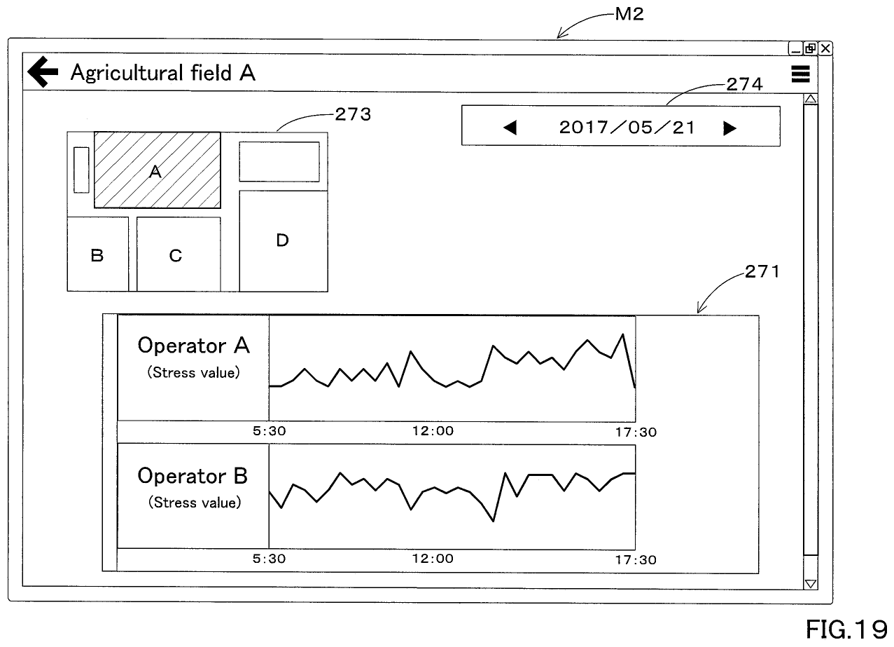

FIG. 19 shows an example of the working display screen M2 displayed on the display device 262. The biological condition display portion 271 displays an operator name indicating an operator who has performed the working on the selected agricultural field (the selected field) on the set date (the selected date), and displays the stress value of the operator calculated by the stress calculator 280 with use of a character, a numerical value, a figure or the like. In particular, after displaying the working display screen M2 on the display device 262 of the computer (the terminal) 263, the support device 260 refers to the storage portion 260a, and calculates the agricultural field using, as a key, the machine position corresponding to the selected date, calculates the operator using, as a key, the personally-identifying information included in the vital data associated with the machine position and the like, and displays the operator name on the biological condition display portion 271. In addition, the stress calculator portion 280 of the support device 260 calculates the stress value of the operator, and sequentially displays the calculated stress value of the operator. In addition, the working calculator portion 260b of the support device 260 refers to the storage portion 260a, calculates the agricultural working corresponding to the operator, and displays, on the working display portion 272, the agricultural working name corresponding to the calculated agricultural working. In the above-described embodiment, the agricultural working is calculated from the operation information. Alternatively, the operation of the agricultural machine may be calculated based on the operation information, and the relation between the operation and the stress value may be displayed. For example, it is judged from the operation information whether the steering is turned, whether the engine revolving speed is changed by pressing the accelerator, or whether the coupling portion 8 is moved upward or downward. Then, the working display portion 272 may display the relation between the operation of the agricultural machine and the stress value.

In addition, when the working is performed by a plurality of operators in the selected agricultural field, the biological condition display portion 271 displays the stress values of the plurality of operators. In addition, the biological condition display portion 271 emphasizes and displays a time zone in which the stress value rises high among the stress values of the operators displayed in time series.

Thus, the agricultural support system includes the stress calculator portion 280, and the display device 262 displays the operation information and the stress value calculated by the stress calculator portion 280. It is possible to visually grasp the stress value based on the vital data of the operator and the operation information of the agricultural machine. For example, when the working is performed by the plurality of operators, it is possible to grasp both the stress value of each operator and the working of each operator using the agricultural machine.

In addition, it is possible to sequentially grasp the change of the stress value generated when the agricultural machine is moved, and it is possible to grasp what kind of operation gives the high stress value.

### Seventh Embodiment

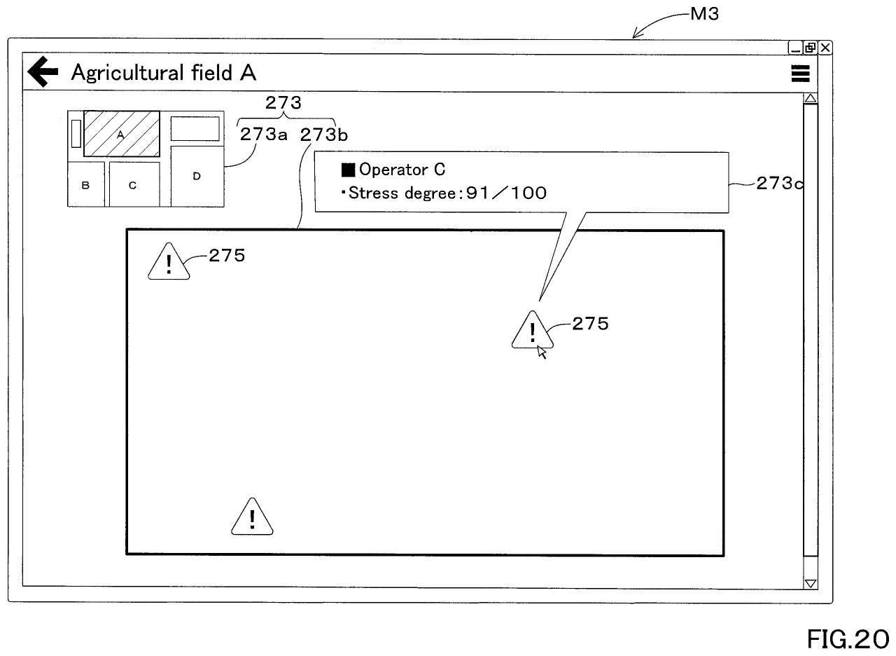

FIG. 20 is a view showing an agricultural support system according to the seventh embodiment of the present invention. In the seventh embodiment, configurations different from those of the first embodiment to the sixth embodiment will be described below. The display device 262 is a device that displays the relation between the operation information, the machine position, and the vital data. That is, the display device 262 displays the stress value calculated by the stress calculator portion 280, information on the machine position where the stress has occurred, and information on the operation information.

FIG. 20 shows an example of a working display screen M3 displayed on the display device 262 according to the third embodiment. The display device 262 will be described with reference to FIG. 20.

As shown in FIG. 20, the working display screen M3 includes an agricultural field display portion 273. The agricultural field display portion 273 includes a first display portion 273a and a second display portion 273b. The first display portion 273a is a portion which displays an agricultural field map, displays a plurality of agricultural fields, and allows an operator to choice one or more agricultural field from the displayed agricultural fields. The second display portion 273b is a portion which shows the enlarged view of the agricultural field selected in the first display portion 273a. On the second display portion 273b, a machine position (a position on the agricultural field) where the operator's stress value is equal to or greater than a threshold value in the agricultural work is displayed by a mark portion 275 such as a graphic. The mark portion 275 is selectable, and when the mark portion 275 is selected, a third display portion 273c indicating detailed information given when the stress value is equal to or greater than the threshold value is displayed. In the third display portion 273c, the operator name indicating the operator whose stress value is equal to or greater than the threshold value, the stress value of the operator, and the like are indicated by letters, numbers, figures, and the like. In addition, the third display portion 273c displays the agricultural working performed by the operator.

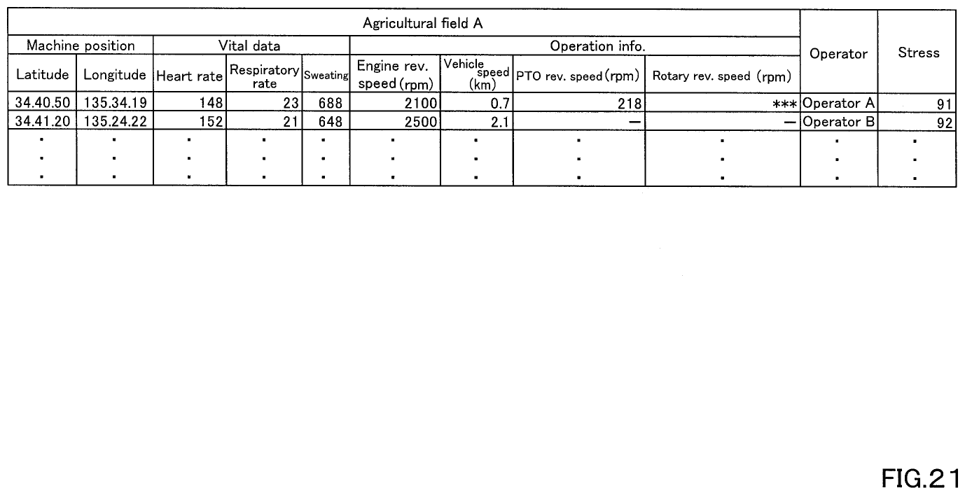

After the computer (the terminal) 263 logs in to the support device 260, when the computer 263 requests the support device 260 for the displaying of the working display screen M3, the support device 260 displays the working display screen M3 on the display device 262 of the computer 263. Here, when an agricultural field is selected on the first display portion 273a, the support device 260 refers to the storage portion 260a, and extracts the machine position, the vital data, and the operation information in the selected agricultural field. FIG. 21 shows an example of the machine position, the vital data, and the operation information of the case where the agricultural field A is selected. As shown in FIG. 21, the support device 260 extracts the machine position and the operation information corresponding to a stress value of 90 or more. The stress value is a value calculated by the stress calculator portion 280, and the agricultural working (the agricultural working name) is the agricultural working calculated by the working calculator portion 260b. The support device 260 displays the extracted machine position as the mark portion 275 of the second display portion 273b. In addition, when a predetermined one of the mark portions 275 is selected from the plurality of mark portions 275, the support device 260 displays the agricultural working name, the operator name, and the stress value corresponding to the selected mark portion 275 on the third display portion.

Thus, the agricultural support system includes the position detector device 222, and the display device 220c displays the relation between the operation information, the machine position, and the vital data. Thus, it is possible to grasp the operation information of the agricultural machine, the machine position, and the vital data of the operator can be associated with each other. In this manner, it is possible to visually grasp the state and location of the agricultural machine, which are given when the vital data of the operator varies in the agricultural field.

In addition, the agricultural support system includes a stress calculator portion 280, and the display device 220c displays the stress value calculated by the stress calculator portion 280, the machine position where the stress occurs, and the operation information. Based on the vital data, it is possible to grasp the place where the stress occurs during the agricultural working. In this manner, it is possible to map a place where the stress occurs in the agricultural field, that is, a place at which the operator should pay attention on the agricultural working.

In the above description, the embodiment of the present invention has been explained. However, all the features of the embodiment disclosed in this application should be considered just as examples, and the embodiment does not restrict the present invention accordingly. A scope of the present invention is shown not in the above-described embodiment but in claims, and is intended to include all modified examples within and equivalent to a scope of the claims.

What is claimed is:

1. An operation support system for a working machine comprising:
a biological condition detector device to detect vital data of an operator, the biological condition detector device being attached to the operator;
a relating portion to relate the biological condition detector device to the working machine configured to travel;
an abnormality detector to detect, from the vital data, abnormality of the operator to which the biological condition detector device related to the working machine is attached; and
a stopping controller to stop the working machine related to the biological condition detector device when the abnormality detector detects the abnormality of the operator, the biological condition detector device being attached to the operator.

2. The operation support system for the working machine according to claim 1,
wherein when the abnormality detector detects the abnormality of the operator representing leaning of the operator and the working machine is in traveling, the stopping controller stops the traveling of the working machine in traveling.

3. The operation support system for the working machine according to claim 1,
wherein when the abnormality detector detects the abnormality of the operator representing leaning of the operator and the working machine is in operation, the stopping controller stops the operation of the working machine in traveling.

4. The operation support system for the working machine according to claim 1,
wherein when the abnormality detector detects the abnormality of the operator representing a bad physical condition of the operator and the working machine is in traveling, the stopping controller stops the traveling of the working machine in traveling.

5. The operation support system for the working machine according to claim 1,
wherein when the abnormality detector detects the abnormality of the operator representing a bad physical condition of the operator and the working machine is in operation, the stopping controller stops the operation of the working machine in traveling.

6. The operation support system for the working machine according to claim 3, comprising:
a rotation shaft supported rotatably in the working machine; and
a working tool arranged on the rotation shaft in the working machine,
wherein the stopping controller is configured to stop rotation of the rotation shaft.

7. The operation support system for the working machine according to claim 1,
wherein the relating portion, the abnormality detector, and the stopping controller are provided in the working machine.

8. The operation support system for the working machine according to claim 1,
wherein the biological condition detector device includes the abnormality detector and is a portable device.

9. A working machine comprising:
a working device to perform working;
a traveling device to perform traveling;
a first obtaining portion to obtain vital data of the operator from a biological condition detector device configured to detect the vital data of the operator, the biological condition detector device being attached to the operator;
an abnormality detector to detect, based on the vital data obtained by the first obtaining portion, abnormality of the operator; and
a stopping controller to stop the working device or the traveling device when the abnormality detector detects the abnormality of the operator.

10. The working machine according to claim 9, comprising
a judging portion to judge whether the biological condition detector device that outputs the vital data obtained by the first obtaining portion is related,
wherein the working device or the traveling device stops when the judging portion determines that the biological condition detector device is related and when the abnormality detector detects abnormality of the operator.

11. An operation support system for an agricultural machine, comprising:
a biological condition detector device to detect vital data of an operator who operates the agricultural machine;
a position detector device to detect a machine position of the agricultural machine;
an agricultural field information obtaining portion to obtain agricultural field information that is information on an agricultural field; and
a control device to control the agricultural machine based on the vital data detected by the biological condition detector device, the machine position detected by the position detector device, and the agricultural field information.

12. The operation support system for the agricultural machine according to claim 11,
wherein the control device has:
a first calculator to calculate a distance between the machine position and a boundary of the agricultural field based on the machine information and the agricultural field information; and
a first controller to control the agricultural machine based on the vital data and the distance.

13. The operation support system for the agricultural machine according to claim 12,
wherein the first controller stops the agricultural machine when the distance is equal to or less than a threshold and when the vital data indicates that the operator do not awake or indicates a bad physical condition of the operator.

14. The operation support system for the agricultural machine according to claim 12,
wherein the first controller controls an operation device of the agricultural machine when the distance is equal to or less than a threshold and when the vital data indicates that the operator do not awake or indicates a bad physical condition of the operator.

15. An operation support system for an agricultural machine, comprising:
a biological condition detector device to detect vital data of an operator who operates the agricultural machine;
a position detector device to detect a machine position of the agricultural machine;
a route obtaining portion to obtain a scheduled traveling route of the agricultural machine; and
a control device to control the agricultural machine based on the vital data detected by the biological condition detector device, the machine position detected by the position detector device, and the scheduled traveling route.

16. The operation support system for the agricultural machine according to claim 15,
wherein the control device has:
a second calculator to calculate, based on the machine position and the agricultural field information, a traveling position of the agricultural machine with respect to the scheduled traveling route; and
a second controller to control the agricultural machine based on the vital data and the traveling position.

17. The operation support system for the agricultural machine according to claim 16,
wherein the second controller stops the agricultural machine when the traveling position represents at least a turn position on the scheduled traveling route and when the vital data indicates that the operator do not awake or indicates a bad physical condition of the operator.

18. The operation support system for the agricultural machine according to claim 16,
wherein the second controller controls an operation device of the agricultural machine when the traveling position represents at least a turn position on the scheduled traveling route and when the vital data indicates that the operator do not awake or indicates a bad physical condition of the operator.

19. The operation support system for the agricultural machine according to claim 16,
wherein the control device has
a third controller to control traveling of the agricultural machine based on the scheduled traveling route,
and wherein the second controller stops the agricultural machine in priority to the traveling controlled by the third controller.

20. An operation support method for an agricultural machine, comprising steps of:
detecting vital data of an operator who operates the agricultural machine;
detecting a machine position of the agricultural machine;
obtaining agricultural field information that is information on an agricultural field; and
controlling the agricultural machine based on the vital data, the machine position, and the agricultural field information.

21. An agriculture support system, comprising:
a biological condition detector device to detect vital data of an operator;
a data collecting device to collect operating information of an agricultural machine; and
a display device to display information on the vital data detected by the biological condition detector device and display information on the operating information collected by the data collecting device.

22. The agriculture support system according to claim 21, comprising
an operation calculator to calculate an agricultural operation based on the operating information,
wherein the display device displays the vital data and the agricultural operation calculated by the operation calculator.

23. The agriculture support system according to claim 21, comprising
a stress calculator to calculate a stress value of an operator based on the vital data,
wherein the display device displays the operating information and the stress value calculated by the stress calculator.

24. The agriculture support system according to any one of claim 21, comprising
a position detecting device to detect a machine position of the agricultural machine,
wherein the display device displays a relation between the operating information, the machine position, and the vital data.

25. The agriculture support system according to claim 21, comprising
a stress calculator to calculate a stress value of an operator based on the vital data,
wherein the display device displays the operating information, the stress value calculated by the stress calculator, and the machine position at which the stress value occurs.
